(19) United States
(12) Patent Application Publication
(10) Pub. No.: US 2021/0403004 A1
(43) Pub. Date: Dec. 30, 2021

(54) DRIVER MONITORING SYSTEM (DMS) DATA MANAGEMENT

(71) Applicant: Intel Corporation, Santa Clara, CA (US)

(72) Inventors: Ignacio J. Alvarez, Portland, OR (US); Marcos Carranza, Portland, OR (US); Ralf Graefe, Haar (DE); Francesc Guim bernat, Barcelona (ES); Cesar Martinez-spessot, Hillsboro, OR (US); Dario Oliver, Hillsboro, OR (US); Selvakumar Panneer, Portland, OR (US); Michael Paulitsch, Ottobrunn (DE); Rafael Rosales, Bavaria (DE)

(73) Assignee: Intel Corporation

(21) Appl. No.: 17/471,411

(22) Filed: Sep. 10, 2021

(51) Int. Cl. B60W 40/09; G06K 9/62; G06N 20/00; H04W 4/40

(52) U.S. Cl. CPC B60W 40/09; H04W 4/40; G06N 20/00; G06K 9/6256

(57) ABSTRACT

Techniques are disclosed to address issues related to the use of personalized training data to supplement machine learning trained models for Driver Monitoring System (DMS), and the accompanying mechanisms to maintain confidentiality of this personalized training data. The techniques disclosed herein also address issues related to maintaining transparency with respect to collected sensor data used in a DMS. Additionally, the techniques disclosed herein facilitate the generation of a digital representation of a driver for use as supplemental training data for the DMS machine learning trained models, which allow for DMS algorithms to be tailored to individual users.

### TECHNICAL FIELD

The disclosure described herein generally relates to driver monitoring systems (DMS) and, in particular, to techniques for migrating data used in the operation of a DMS.

### BACKGROUND

Driver monitor systems (DMS) typically include various types of sensors configured to monitor the driver of a vehicle and to perform various safety-related functionalities. Examples of DMS include the use of cameras, infrared sensors, and/or biometric sensors to monitor driver attentiveness, to detect fatigue, to identify whether the driver is paying attention to the road, to identify an emergency medical condition, etc. Based upon the particular implementation, a DMS may issue a warning when an unsafe condition is detected, which is intended to alert the driver and to ensure the driver's focus remains on the road. Other more recent DMS configurations may further leverage the use of advanced driving assistance (ADAS) systems to automatically apply the brakes, steer, contact emergency services, etc. when an unsafe condition is detected.

Current DMS implementations may rely on machine learning trained models to identify specific conditions or behaviors. Such implementations may use these trained models in conjunction with acquired sensor data, which may require the use of in-cabin facing cameras that capture images of the driver and/or passengers. Moreover, the acquired sensor data may include biometric information. Thus, the current usage of DMS and the accompanying data that is collected has called into question privacy issues related to the use of collected sensor data outside of the vehicle environment. Current DMS implementations also suffer from drawbacks related to the model being trained with a training data set that may not adequately represent all potential users with respect to differences in race, skin tone, specific conditions that may deviate from typical user features, etc. Thus, current DMS are inadequate.

### BRIEF DESCRIPTION OF THE DRAWINGS/FIGURES

The accompanying drawings, which are incorporated herein and form a part of the specification, illustrate the present disclosure and, together with the description, further serve to explain the principles and to enable a person skilled in the pertinent art to make and use the techniques discussed herein.

In the drawings, like reference characters generally refer to the same parts throughout the different views. The drawings are not necessarily to scale, emphasis instead generally being placed upon illustrating the principles of the disclosure. In the following description, reference is made to the following drawings, in which:

FIG. 1 illustrates a DMS configured to perform drowsiness level detection using a machine learning trained model, as is known in the art;

FIG. 2 illustrates end-to-end interactions between trusted and confidential components, in accordance with the present disclosure;

FIG. 3 illustrates an attestation sequence between a user and cloud enclaves, in accordance with the present disclosure;

FIG. 4 illustrates confidential information provisioning for re-training, in accordance with the present disclosure;

FIG. 5 illustrates an internal DMS to drowsiness level detection algorithm API definition, in accordance with the present disclosure;

FIG. 6 illustrates an attestation sequence between a vehicle enclave and a cloud enclave with consent from a user, in accordance with the present disclosure;

FIG. 7 illustrates provisioning and execution of a hyper-personalized confidential algorithm, in accordance with the present disclosure;

FIG. 8 illustrates a process flow, in accordance with the present disclosure.

FIG. 9 illustrates an architecture for providing transparency of collected sensor data, in accordance with the disclosure.

FIG. 10 illustrates a grouping of in-vehicle monitoring features by use-case, in accordance with the disclosure.

FIG. 11 illustrates usage of specific type of cameras that may be used in these different use cases, in accordance with the disclosure.

FIG. 12 illustrates a grouping of in-vehicle monitoring features by vehicle type and user role, in accordance with the disclosure.

FIG. 13 illustrates displayed anonymized collected sensor data used for machine learning training, in accordance with the disclosure.

FIG. 14 illustrates a flow for user privacy profile management, in accordance with the disclosure.

FIG. 15 illustrates a process flow, in accordance with the present disclosure.

FIG. 16A illustrates a rendering of realistic human characters using Metahuman to model different racial features, in accordance with the disclosure.

FIG. 16B illustrates a rendering of realistic human characters using Metahuman to highlight skeleton joints to control a 3D avatar, in accordance with the disclosure.

FIG. 17 illustrates the high level of detail achieved via the rendering of realistic human characters, in accordance with the disclosure.

FIG. 18 illustrates a process flow for generating a user-specific dataset for machine learning model training, in accordance with the disclosure.

FIG. 19 illustrates a user interface (UI) that enables user adjustment and validation of a generated 3D mesh, in accordance with the disclosure.

FIG. 20 illustrates a process flow for the implementation of DMS-based functions using a creation stage and a monitoring stage, in accordance with the disclosure.

FIG. 21 illustrates a process flow for the implementation of DMS-based functions for multiple users, in accordance with the disclosure.

FIG. 22 illustrates a process flow, in accordance with the present disclosure.

The present disclosure will be described with reference to the accompanying drawings. The drawing in which an element first appears is typically indicated by the leftmost digit(s) in the corresponding reference number.

### DETAILED DESCRIPTION

The following detailed description refers to the accompanying drawings that show, by way of illustration, exemplary details in which the disclosure may be practiced. In the following description, numerous specific details are set forth in order to provide a thorough understanding of the present disclosure. However, it will be apparent to those skilled in the art that the various designs, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring the disclosure.

The implementations as described herein are divided into separate Sections for ease of explanation. However, these implementations may be separately utilized or combined with one another. The first Section is directed to addressing issues related to the use of personalized training data to supplement machine learning trained models for DMS, and the accompanying mechanisms to maintain confidentiality of this personalized training data. The second Section is directed to addressing issues related to maintaining transparency with respect to collected sensor data used in a DMS. The third Section is directed to the generation of a digital representation of a driver for use as supplemental training data for the DMS machine learning trained models, which allow for DMS algorithms to be tailored to individual users.

Section I—Confidential Hyper-Personalization of DMS Functionality

The evolution of DMS space is astonishing. Since its introduction to the market in 2006, the capabilities offered by these systems to improve the safety aspects of driving tasks have been expanded towards enabling full automation of the driving experience. To feed this evolution, manufacturers have been continuously expanding the instrumentation and collection of sensor data from the driver cabin environment, and using algorithms to process the collected sensor data to provide more functionality to the driver. Thus, it is common to have a camera capturing driver/passenger behavior, a microphone listening to what vehicle occupants are saying or the used tone, and algorithms that process audio and/or visual data streams in real time. More recently, research on how to monitor a driver's heart beat for use with a DMS has been implemented to provide additional use cases and functionality (e.g. to bring the car to a controlled stop in case of a sudden emergency with the driver's health).

Thus, there seems to be an increasing trend of collecting more data about the drivers and passengers. And to make the DMS functionality more capable and accurate, data collection will become more targeted to the specific persons they are serving. With this increased and targeted type of data collection, privacy concerns arise. The techniques described in this Section aim to address current and future privacy concerns of DMS expanded functionality by providing mechanisms to maintain personal data under a user's ownership, but at the same time allowing the DMS to use the insights of that data to enhance the driver and passenger experience and safety.

Generally, current solutions in DMS development focus on cybersecurity and trust but do not address the confidentiality or protection of collected data with respect to vehicle passengers. For example, some automotive chip vendors offer cybersecurity and trust solutions by way of integrated chips, which are aimed at enhancing the cybersecurity of the target platform and provide the means for stablishing a hardware root of trust. However, such solutions are focused on providing automotive manufacturers and their ecosystem with silicon IP for cybersecurity, and there is no data confidentiality of the final user (e.g. the driver) in mind. Moreover, Electronic Design Automation (EDA) tools with cybersecurity and trust capabilities place cybersecurity and trust in the front and center of their offerings. Such solutions aim to provide building blocks for system developers to guarantee cybersecurity functions and data protection requirements. However, such EDA tools are likewise not focused on driver confidentiality, but instead on providing tools to system developers to implement cybersecurity function in their platforms (including the DMS).

Furthermore, currently no solutions are known for DMS development with respect to the implementation of confidential computing. Instead, most current efforts are driven by Cloud Service Providers (CSP) like Microsoft to allow confidential workloads to execute in their infrastructure. For instance, Microsoft Azure confidential computing provides infrastructure with confidential computing capabilities, allowing for an isolation of sensitive data while being processed in the cloud. But such solutions are not presently tailored to operate in the DMS space, as target applications include the Finance, Health, and artificial intelligence (AI)/machine learning (ML) ecosystems. As another example, the Confidential Computing Consortium (CCC) sponsored Open Enclave SDK, and implementations such as Confidential ONNX Inference Server provide the building blocks for creating confidential workloads, and also reference implementation to showcase how to use this technology for AI/ML Inference.

Furthermore, on the regulations and compliance side, there are some efforts to standardize the cybersecurity requirements of the smart cars and autonomous vehicles. This includes the ISO/SAE FDIS 21434 Standard, which is under development at the time of this writing, and aims to define the cybersecurity engineering requirements for road vehicles with the purpose of enabling the engineering to keep up with changing technology and relevant attack methods, and to increase the cyber-security for vehicles over their entire life cycle. However, this Standard is mostly related to the software lifecycle with respect to security, as the Standard lays out the basic requirements for cybersecurity and is not directed to confidentiality of data.

Thus, conventional solutions do not consider confidentiality with respect to the end user (e.g. the vehicle driver and occupants). Instead, these conventional approaches provide car manufacturers and providers with tools and technology for capturing and processing data securely. In other words, the present focus is on the car vendors. In contrast, the techniques described in this Section focus on protecting the privacy and confidentiality of drivers and occupants. To do so, the techniques described in this Section provide users with the means for accessing current and future functionalities of the DMS without having to sacrifice their privacy to a DMS developer. By leveraging confidential computing techniques, the mechanism and interactions between the owner of the data and the provider of the system are described that allow for a Hyper-Personalization of DMS functionalities towards improving safety and overall experience while preserving confidentiality. In this way, the user is the owner of the data, can verify that the data was not disclosed to unwanted third parties, and can effectively opt-out of unwanted DMS functionality.

The techniques described herein provide cybersecurity and use a confidentiality-based approach in the automotive ecosystem. The techniques described herein enable users to develop DMS with the technological assurance of correct personal identifiable data handling while minimizing the risk of data breaches. The techniques described herein aim to eliminate the barrier to unleashing the power of AI/ML, while addressing concerns about the amount of data collection required to make it work.

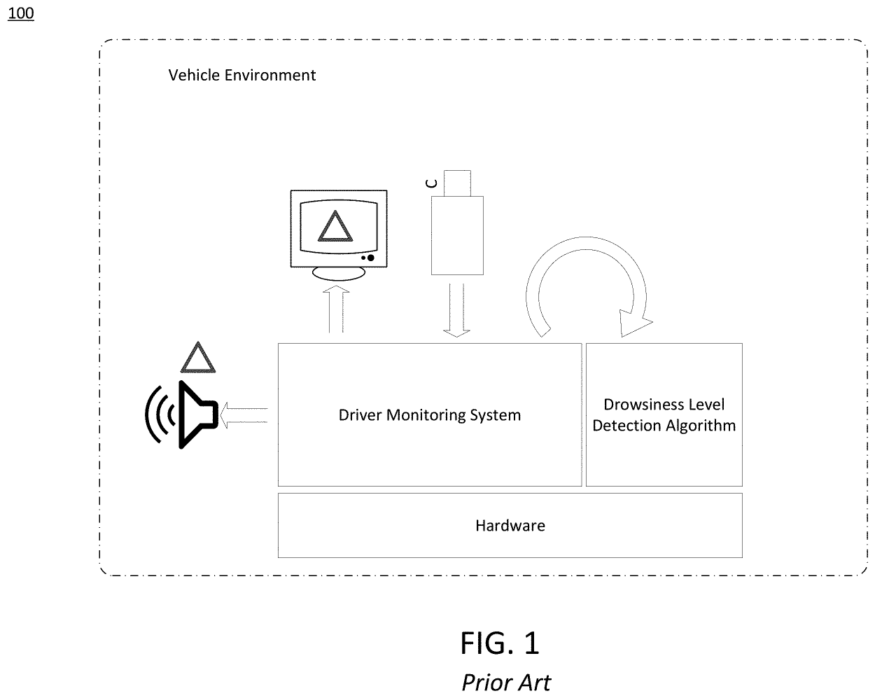

FIG. 1 illustrates a DMS configured to perform drowsiness level detection using a machine learning trained model, as is known in the art. In the scenario as illustrated in FIG. 1, it is assumed that a person recently acquired a brand-new “smart” vehicle. In this vehicle, the (conventional) DMS uses artificial intelligence to provide several safety related functionalities. One of those functionalities includes a driver's drowsiness detection, which uses the input from a camera placed on the steering column to compute the driver's drowsiness level, and then triggers a visual and audible alarm when a detected drowsiness level exceeds a predetermined threshold. Internally, the drowsiness level detection algorithm uses a neural network (NN) to process image frames from the camera. The NN was trained using a dataset available at the car manufacturer's premises and was thoroughly tested.

The person begins to drive the vehicle, and when the vehicle reaches a certain speed, the DMS starts processing the camera feeds. After a few seconds, the alarms are trigged because of an unsafe drowsiness detected in the driver. Unfortunately for this driver, the dataset used for training the model produced an NN that is very sensitive to sore eyes. This driver has a medical condition called Sjogren syndrome, which is one of the most common auto-immune diseases that makes the eyes permanently sore, and unfortunately does not have a known cure. The driving experience is now very frustrating, as the alarms are triggered when the oversensitive drowsiness detection system frequently identifies (incorrectly) that the driver is tired.

The driver may then contact the vehicle manufacturer to complain about this issue, and the vehicle manufacturer may inquire regarding the details of operation. This may lead to a request for the driver to disclose information about a medical condition, which the driver may not be comfortable doing due this medical condition being a matter of personal health. Other issues with using general training datasets in this way for DMS functionality may result from a failure to include or adequately represent, as part of the training data, other factors such as race, skin tone, etc.

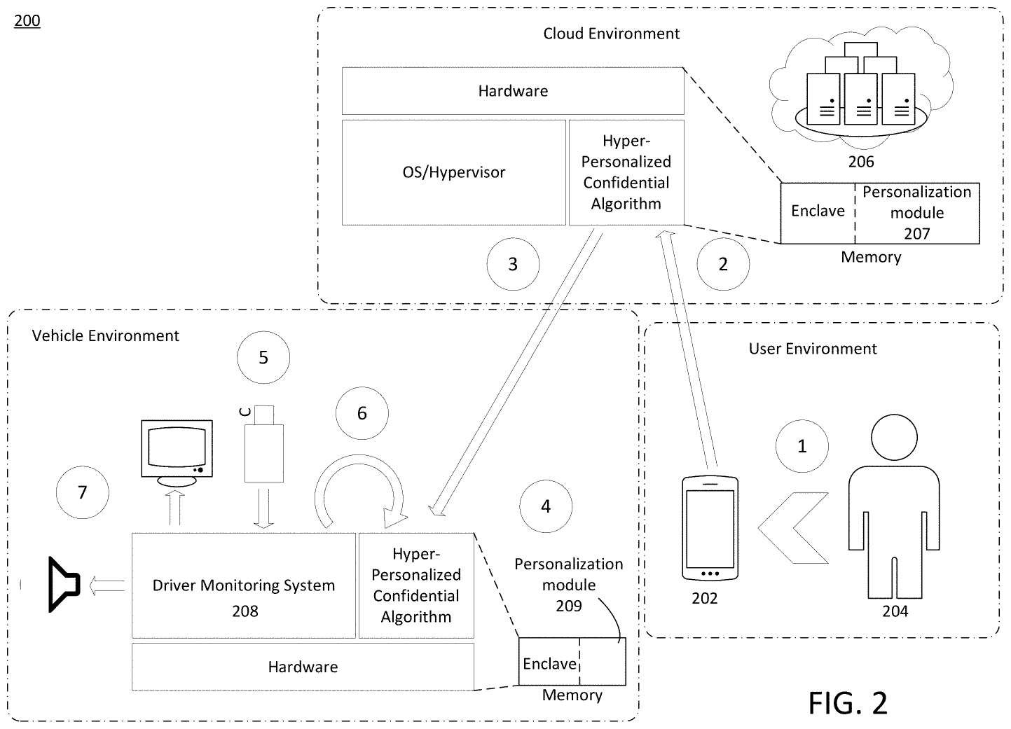

Thus, the techniques described in this Section address such scenarios in which it is desirable to implement the power of AI and state-of-the-art technology implemented by modern DMS while maintaining privacy and confidentiality. As further discussed below, this Section describes techniques that ensure both the personalization of DMS functionality on a per-user and per-vehicle basis, and also facilitate the confidentiality of user data used to enable this personalization. These techniques include various mechanisms and interactions among components identified with different environments and systems to personalize the functionality of the DMS to the specifics of a person while maintaining the data required for that personalization confidential and under the control of the person. As further discussed below with reference to FIG. 2, these different environments may include that of the user, the cloud, and the vehicle.

FIG. 2 illustrates end-to-end interactions between trusted and confidential components, in accordance with the present disclosure. A DMS architecture 200 is shown in FIG. 2, which enables the training and operation of a DMS associated with a vehicle. As shown in FIG. 2, each of the user environment, the cloud environment, and the vehicle environment comprises various components configured to perform a set of functions to facilitate the operation of the DMS 208. As further discussed in this Section, a numbered sequence of interactions is shown in FIG. 2 with respect to the DMS architecture 200, which defines how the DMS 208 may receive personalized machine learning trained models while maintaining confidentiality of the user 204's data. That is, the numbered stages1-8 are shown in FIG. 2, which depict a sequence of various actions, data exchanges, and mechanisms, ensure that user data collected via the UE 202 is securely and confidentially used to personalize a machine learning trained model implemented by the DMS 208, as further discussed herein.

The DMS architecture 200 as shown in FIG. 1 includes three separate environments: a user environment, a cloud environment, and a vehicle environment. The three separate environments as shown in FIG. 2 are illustrated in a non-limiting sense, and the DMS architecture 200 may include additional, fewer, or alternate environments. Moreover, the various functionalities discussed herein with respect to each environment are also intended to be non-limiting. That is, any one of the user environment, cloud environment, and vehicle environment may perform any of the functionalities in addition to or instead of those performed by the components of the other environments.

The user environment comprises a user equipment (UE) 202, which may be identified with a user 204. The UE 202 may be implemented as any suitable type of electronic device configured to perform wireless communications, such as a mobile phone, computer, laptop, tablet, wearable device, etc. The UE 202 is configured to store and execute one or more applications, such as mobile “apps” that facilitate the collection of personalized data that may be securely transferred and stored in the cloud environment and used to perform personalized machine learning model training. As further discussed below, the models are securely transferred and stored in the vehicle environment for use by the DMS 208 as discussed herein. Thus, although single directional arrows are shown in FIG. 2, the various computing components identified with the user environment, the cloud environment, and the vehicle environment may be configured to communicate with one another using any suitable number and/or type of communication protocols to exchange data between one another uni-directionally and/or bi-directionally.

The cloud environment may comprise any suitable number of computing devices 206, which may be cloud computing devices such as servers, computers, etc. The computing devices 206 may be configured to operate in any suitable type of computing arrangement to perform machine learning training, as further discussed herein. As shown in FIG. 1, the computing devices 206 are identified with hardware, which may be implemented as any suitable number and/or type of processors such as graphics processors, a central processing unit (CPU), support circuits, digital signal processors, integrated circuits, or any other types of devices suitable for running applications and for data processing and analysis. The hardware may also comprise any suitable type of memory that stores data and/or instructions, such as executable instructions identified with the personalization module 207. The memory can be any well-known volatile and/or non-volatile memory, including read-only memory (ROM), random access memory (RAM), flash memory, a magnetic storage media, an optical disc, erasable programmable read only memory (EPROM), and programmable read only memory (PROM). The memory can be non-removable, removable, or a combination of both.

The hyper-personalized confidential algorithm may be stored, instantiated, or otherwise maintained for execution via the computing devices 206. The computing devices 206 may further include an operating system and/or a hypervisor. A hypervisor is also known as a virtual machine monitor or VMM, and is software that creates and runs virtual machines (VMs). A hypervisor allows one host computer from the computing devices 206 to support multiple guest VMs by virtually sharing its resources, such as memory and processing. As further discussed herein, the hardware identified with the computing devices 206, in conjunction with the OS/hypervisor and executable instructions identified with the personalization module 207, enable data to be received from the UE 202 and securely stored via execution of any suitable type of machine-readable instructions. The data that is securely stored in this manner may then be used by the computing devices 206 to train personalized machine learning models, which may include the hyper-personalized confidential algorithm, and are then deployed to the DMS 208. Additional details regarding this process are further discus sed herein.

The vehicle environment comprises the DMS 208 of one or more accompanying vehicles that may use the personalized machine learning trained models received from the cloud environment to perform DMS safety-related functions. Thus, the hardware, DMS 208, and hyper-personalized confidential algorithm as shown in FIG. 1 may be identified with any suitable components of a vehicle. The hardware may be implemented as any suitable number and/or type of on-board vehicle processors such as graphics processors, a central processing unit (CPU), support circuits, digital signal processors, integrated circuits, or any other types of devices suitable for running applications and for data processing and analysis. The hardware may also comprise any suitable type of memory that stores data and/or instructions, such as the instructions identified with the personalization module 209. The memory can be any well-known volatile and/or non-volatile memory, including read-only memory (ROM), random access memory (RAM), flash memory, a magnetic storage media, an optical disc, erasable programmable read only memory (EPROM), and programmable read only memory (PROM). The memory can be non-removable, removable, or a combination of both.

The vehicle identified with the vehicle environment may also additionally comprise any suitable number and/or type of components that are commonly associated with a vehicle and/or DMS system such as cameras, infrared sensors, LIDAR sensors, in-vehicle infotainment systems (IVI), one or more displays, speakers, etc. Thus, the DMS 208 may utilize any suitable type of machine learning trained model to perform DMS functions, such as safety related functions, and alert the driver in any suitable manner when a particular condition, unsafe behavior, etc. is detected via use of the machine learning trained model as further discussed herein.

The hyper-personalized confidential algorithm may be stored, instantiated, or otherwise maintained for execution via any suitable number of vehicles identified with the vehicle environment. As further discussed herein, the hardware identified with a vehicle (e.g. processing circuitry, one or more processors, etc.) may execute locally-stored machine-readable instructions identified with the personalization module 209 to enable the personalized machine learning trained models to be received from the cloud environment and securely stored in the vehicle environment in vehicle memory. The personalized machine learning trained models that are securely stored in this manner may then be used by the DMS 208 to perform DMS related functions. Thus, the hyper-personalized confidential algorithms as shown in FIG. 2 may be identified with a specific type of DMS algorithm that facilitates a specific type of DMS-related functionality (e.g. the aforementioned driver drowsiness level detection). The DMS 208 uses the hyper-personalized confidential algorithm to perform DMS-related functions in accordance with a specific personalized machine learning trained model, which is trained in the cloud environment in this non-limiting scenario. Additional details regarding this process are further discussed herein.

For ease of explanation, the use of drowsiness detection as discussed above with reference to FIG. 1 is further used in this Section to provide a scenario with respect to the overall sequence of stages 1-8 as shown in FIG. 2, which are implemented to enable the DMS to perform safety related functions using a personalized machine learning trained model while maintaining confidentiality of user data. This scenario references the use of a drowsiness level detection algorithm, which may be identified with the functionality of the hyper-personalized confidential algorithm as shown in FIG. 2. Thus, continuing this scenario, the hyper-personalized confidential algorithm that is used by the computing devices 206 in the cloud environment to perform the machine learning model training, as well as the hyper-personalized confidential algorithm that is implemented by the DMS 208 to perform safety related functions, is identified with a drowsiness level detection algorithm. However, unlike the drowsiness level detection algorithm used by the conventional DMS of FIG. 1, the DMS 208 as described herein with reference to FIG. 2 uses the hyper-personalized confidential algorithm, which ensures that the DMS functionality is personalized while maintaining the confidentiality of user data that enables this personalization. It will be understood that this is a non-limiting scenario, and it the implementations as described herein may be applied with any suitable type of algorithm and DMS functionality in accordance with the particular machine learning trained model and/or components of the vehicle environment that is/are implemented.

With continued reference to FIG. 2, stage 1 is identified with the user environment, and includes an initial process of personalizing the DMS drowsiness detection system with an opt-in from the user 204. The user 204 may be a driver or other occupant of the vehicle identified with the vehicle environment, whom will be a target of the monitoring functionality performed by the DMS 208. As further disused below, the user 204 may be identified with one vehicle or, alternatively, the vehicle environment may include any suitable number of different vehicles. The UE 202 is assumed to be owned or otherwise identified with the user 204 and thus trusted by the user 204. The UE may execute any suitable type of application that may communicate with one or more components of the cloud environment and/or the vehicle environment, as discussed herein. The UE 202 may implement an application that is configured to trigger a trusted re-training process with respect to the machine learning trained model implemented by the hyper-personalized confidential algorithm that is utilized by the DMS 208. To do so, the UE 202 is configured to implement any suitable type of communication protocols that may interface with the vehicle identified with the vehicle environment. This may include the use of a near field communication (NFC) protocol, a Bluetooth communication protocol, etc. The user 204 may thus use the UE 202 to communicate with the DMS 208 by bringing the UE 202 in close proximity of the vehicle identified with the DMS 208 (such as via tapping for an NFC device) to establish an authentication or “handshake” between the UE 202 and the DMS 208. This authentication procedure may be executed in accordance with any suitable techniques, including known techniques, which utilize any suitable type of communication protocol to establish communications between the UE 202 and the vehicle(s) identified with the vehicle environment.

Regardless of how the authentication procedure is performed, upon this authentication being completed, an application is triggered to execute on the UE 202, which is configured to capture user data for re-training the machine learning model used by the DMS 208 (i.e. the machine learning trained model used by the hyper-personalized confidential algorithm, which was originally trained using a manufacturer dataset as noted above). The collection of user data via the UE 202 may include the use of any suitable number and type of sensors identified with the UE 202 to collect relevant data that would typically be used as part of a machine learning model training dataset such as camera images and/or video, audio collected via microphones, LIDAR data, etc.

The application executed via the UE 202 may instruct the user 204 regarding how to capture the necessary images from the face and body, and how to properly add metadata required for the re-training process. This may include drawing bounding boxes on the face and eyes, displaying different emotions to the UE 202 camera (tired, happy, etc.) as requested by the application, etc. Once this process has been completed, the user data is stored in the UE 202. The user data as discussed herein may thus include images and/or audio of the user who may be identified with a driver or other occupant of the vehicle that utilizes the DMS 208, and additionally may include other types of data for re-training the machine learning trained model used by the DMS 208 such as metadata, etc. Assuming that the re-training process is performed as part of the cloud environment infrastructure (as this re-training process may alternatively be performed via the UE 202 or the infrastructure of the vehicle environment), the user data is then communicated to the cloud environment. That is, and as further discussed herein, the computing devices 206 may use the user data to supplement the original training dataset to perform a re-training of the original machine learning trained model, as the original machine learning trained model (such as a NN) was trained using only the original training dataset, as was the case for the example discussed above with respect to FIG. 1 and the use of the drowsiness detection system.

To do so, the computing devices 206 may generate, via the use of the hardware and machine-readable instructions stored in the memory (such as the executable instructions identified with the personalization module 207), an enclave in a secure location of memory. That is, and as noted above, the computing devices 206 may include any suitable number and/or type of processors that may execute computer-readable instructions stored in one or more memory locations, which may be the memory as shown in FIG. 2. The computing devices 206 may thus instantiate an instance of an enclave in memory, and which may be identified with one or more of the computing devices 206 or other suitable computing devices of the cloud environment 206. The enclave may thus be instantiated in and executed from a secure portion of memory, such as a predetermined range of memory addresses, which are protected by one or more processors that execute the hyper-personalized confidential algorithm training process.

The instantiation and execution of the enclave in the cloud environment may be implemented in accordance with any suitable techniques, including known techniques. This may include any suitable technology available for confidential computing purposes, and which may include Intel Software Guard Extensions (Intel SGX). The enclave thus represents a secured portion of the memory that executes a process running in a specific memory location accessed in the cloud environment, but is protected by one or more processors identified with the computing devices 206. In this way, only the allowed process (i.e. the re-training of the machine learning trained model using the user data via the hyper-personalized confidential algorithm) is authorized for use in those secured memory locations. However, the computing devices 206 and the other components of the cloud environment cannot readily access or otherwise view the processes that occur in the enclave due to the secure nature of this portion of memory and the protections provided in accordance with confidential computing processor architecture. Instead, any attempted access to the enclave by such components only yields encrypted ciphertext that is stored in the enclave.

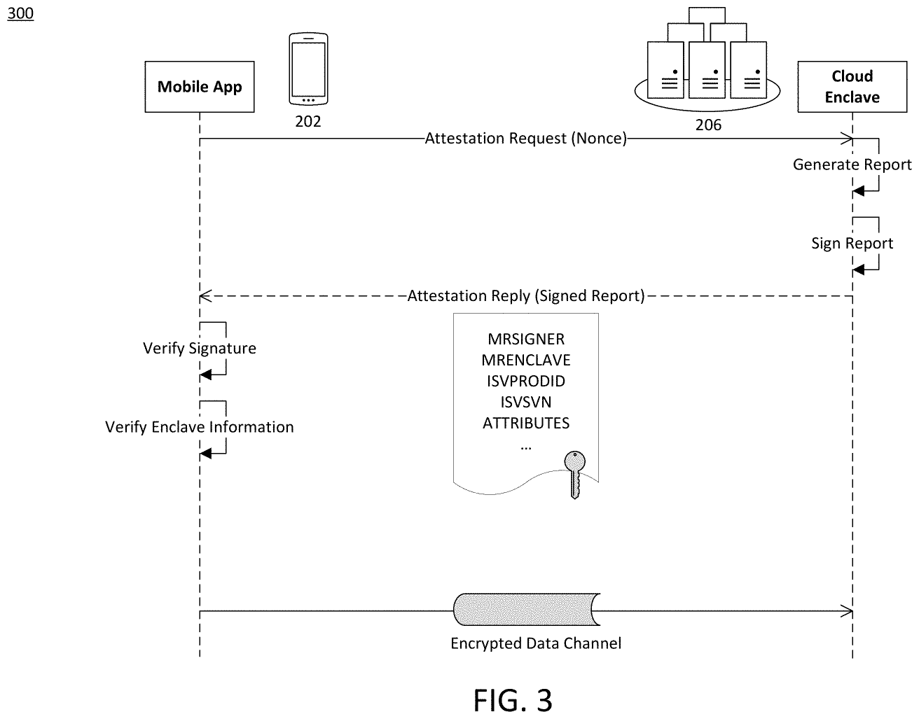

As the enclave is instantiated to handle re-training of the machine learning trained model using the user data, the user data is now transferred from the UE 202 to the cloud environment, which includes transferring the user data to the protected portion of memory identified with enclave as noted above. To transfer the user data in this manner, stage 2 includes establishing a trust relationship between the UE 202 and the cloud enclave instance. As a result of this process, an encrypted communication channel is established between the UE 202 and the cloud enclave instance, i.e. the one or more computing devices 206 or portions thereof that are identified with the cloud enclave instance. Any suitable techniques may be implemented for this purpose, such as the use of an attestation procedure as discussed in further detail below. An attestation procedure verifies the identity and integrity of the cloud enclave against a predetermined or otherwise well-known state. FIG. 3 illustrates an attestation procedure sequence between a user and a cloud enclave for this purpose. The computer-readable instructions stored in the memory of one or more of the computing devices 206 (such as those represented with personalization module 207) may facilitate the computing device(s) 206 to implement the attestation procedure with the UE 202.

As shown in FIG. 3, when an attestation procedure is implemented in this manner, the UE 202 functions as an initiator of the attestation process, and transmits an attestation request that is received by one or more of the computing devices 206. The attestation request represents a data transmission that includes a request to the cloud enclave for metadata to be included in a subsequent data transmission represented in FIG. 3 as an attestation reply, which may alternatively be referred to as a quote. The quote is generated via a report generation and signing process and transmitted back to the UE 202, which is then validated by the UE 202 based upon the requested metadata. The user 204 may then verify the signature and enclave information and, upon completion, it is ensured through this attestation process that the cloud part is a valid enclave for re-training purposes. Visually, the user 204 may verify the signature and enclave information using fingerprints that are reported by the cloud enclave, which are displayed on a screen of the UE 202, and which may include a random art, QR code, or similar format. The user 204 is then invited to validate the fingerprints displayed on the screen of the vehicle identified with the vehicle environment and, upon doing so, a trusted relationship is established between each of the vehicle, the UE 202, and the cloud enclave.

After the attestation process has been completed, an encrypted communication channel is established between the UE 202 and the cloud enclave, as shown in FIG. 3. The user data, which may include images of the user and metadata captured by the user 204 as noted above, may be encrypted at the UE 202 and transmitted to the cloud enclave via this established encrypted data channel. The cloud enclave thus receives the user data and decrypts and temporarily stores the user data in the secured (i.e. processor protected) portion of the memory. The user data stored in this manner may thus form part of a modified training dataset that includes the original training data used to train the machine learning trained model in addition to the user data. The storage of the user data in the secured portion of the memory in the cloud enclave triggers the start of stage 3, which includes a re-training process to generate a personalized machine learning trained model using the modified training dataset, which again includes the personalized user data. The result is a new modified (i.e. personalized) machine learning trained model that may be implemented by the DMS 208.

It is noted that although the user data is transferred to the cloud environment and securely stored in this manner, this is only a temporary measure as the user data is not stored (persisted) in the cloud. Instead, the use of the user data in the cloud is loaded in memory at enclave execution time to re-train the machine learning trained model, and once used for this purpose may be deleted from the cloud environment.

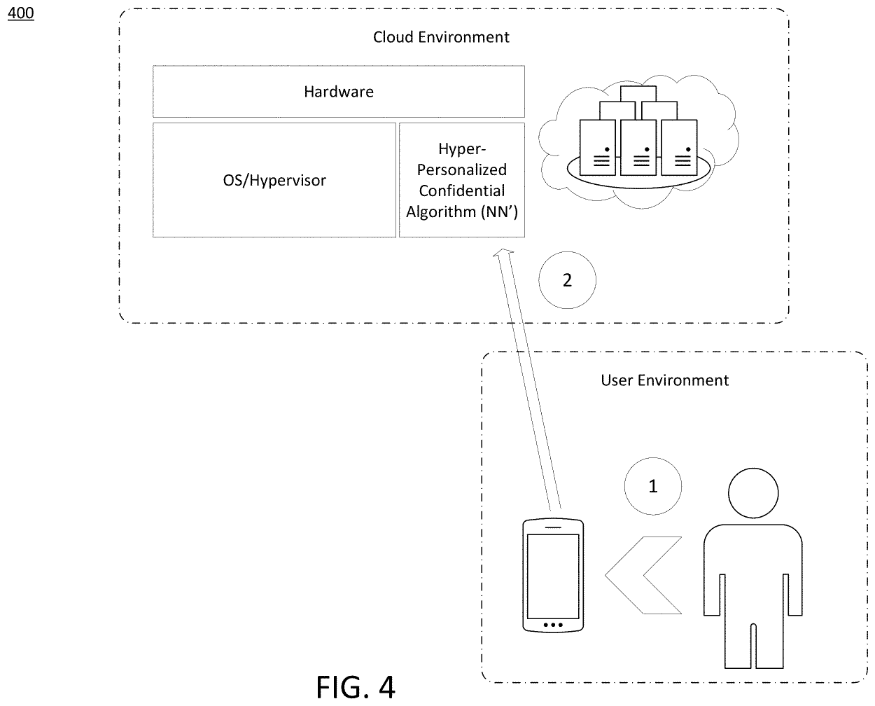

Although the techniques described herein may include any suitable type of machine learning trained models for use with the DMS 208, a neural network (NN) is described in this scenario as a non-limiting implementation. In this scenario, and as shown in further detail in FIG. 4, the original machine learning trained model is represented as NN, and the personalized machine learning trained model, which is the result of re-training the original machine learning trained model with the modified training dataset, is represented as NN′.

As shown in further detail in FIG. 4, the personalized machine learning trained model NN′ needs to be stored for later use in the cloud environment infrastructure. Thus, although the user data is not stored (persisted) in the cloud environment as noted above, the personalized machine learning trained model NN′ is maintained (persisted) in the memory of the cloud environment but stored in an encrypted form in the cloud storage facility. To do so, and to avoid disclosing the contents of NN′, a “Secret Sealing” functionality of the cloud enclave may be implemented. In accordance with this functionality, the cloud enclave may encrypt the personalized machine learning trained model NN′ with a key that is stored in the secured location of the memory to generate an encrypted personalized machine learning trained model NN′. This encrypted personalized machine learning trained model NN′ may then be stored in an unsecured location of the memory in the cloud environment, i.e. in a portion of the memory other than the secure location as noted above. The key may be stored in the secured portion of the memory however, which again is guarded or otherwise protected by the processor in accordance with the confidential computing techniques described herein. The key used to encrypt the encrypted personalized machine learning trained model NN′ is thus only available to the cloud enclave at execution time. In this way, the plain content of this personalized machine learning trained model NN′ (i.e. the decrypted personalized machine learning trained model NN′) is never disclosed to the cloud infrastructure and system components. In other words, after the secret sealing is executed, the encrypted personalized machine learning trained model NN′ may only be decrypted inside the execution context of the enclave.

The personalized machine learning trained model NN′ is to be utilized by the DMS 208, and thus the personalized machine learning trained model NN′ needs to be transferred from the cloud environment to the vehicle environment. For purposes of clarity, a discussion regarding the operation and configuration of the DMS 208 is provided to enable this customization of the internal functionality of the DMS 208.

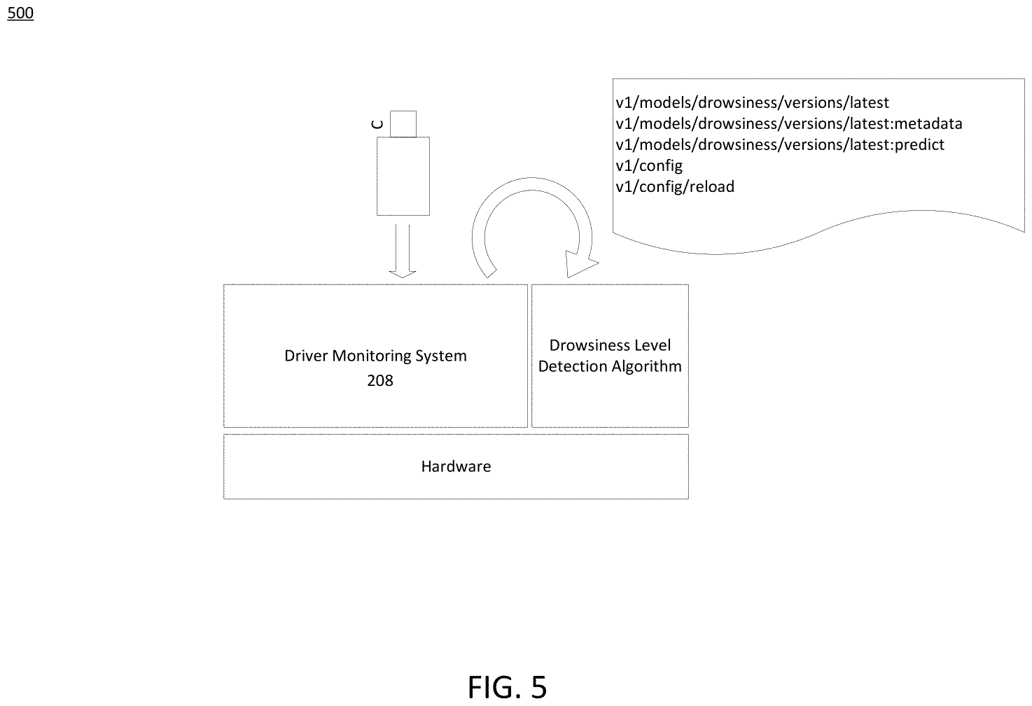

With reference to FIG. 5, the driving environment includes the DMS 208 and accompanying hardware, which form a core or primary system for DMS functionality, whereas the hyper-personalized confidential algorithm, which is implemented as a drowsiness detection algorithm in this scenario, forms a machine learning subsystem that is accessed and utilized by the DMS 208. A defined Application Programming Interface (API) is used to facilitate communications between the core of the DMS 208 and the machine learning subsystem. This API interface is a mechanism exposed by the machine learning subsystem to allow the primary DMS system to submit data to be processed by the personalized machine learning trained model (such as NN′) and get the results of the processing of that data by the personalized machine learning trained model. In other words, the API interface functions to pass machine learning trained models between the primary or core system that consumes such models.

Such an API interface may be implemented with components such as the Intel OpenVINO Model Server, which provides gRPC and/or REST interfaces for applications to consume machine learning trained models loaded by a server. The code snippet as shown in FIG. 5 corresponds to an implementation of an API interface when using a REST model. The API interface may thus enable the personalized machine learning trained models to be modified and reloaded without having to change the application code that consumes them (the contract between the application and the model server is the API definition). In this way, the personalized machine learning trained model does not leave the enclave execution context. Instead, the API interface ensures that the personalized machine learning trained model is further updated (such as with additional training), the core of the DMS 208 does not need to change, as the DMS 208 may call the same API that was previously used to execute the personalized machine learning trained model prior to being re-trained.

Turning now back to FIG. 2, the DMS 208 needs to securely download the personalized machine learning trained model NN′ from the cloud environment, which is identified with the start of stage 4 as shown in FIG. 2. That is, the cloud environment (such as via the computing devices 206) may transmit the personalized machine learning trained model to the vehicle environment (such as the hardware identified with the particular vehicle using the DMS 208). The DMS 208 then may utilize the personalized machine learning trained model as part of a driver monitoring system (DMS). To maintain user data confidentiality, the computing hardware of the vehicle environment also includes technology for performing confidential computation, which may include the same confidential computing architecture as discussed above with respect to the cloud environment. Again, this may include Intel SGX or other suitable confidential computing hardware. Thus, another enclave is instantiated in the vehicle environment via the use of the confidential computing hardware, which may then be used to execute the personalized machine learning trained model. To do so, and as noted above for the cloud environment, the hardware in the vehicle environment comprises memory that includes a secure portion in which processing circuitry identified with the vehicle (i.e. a vehicle processor or processing circuitry identified with the vehicle environment hardware) instantiates an instance of the enclave in the secure portion of the memory as shown in FIG. 2.

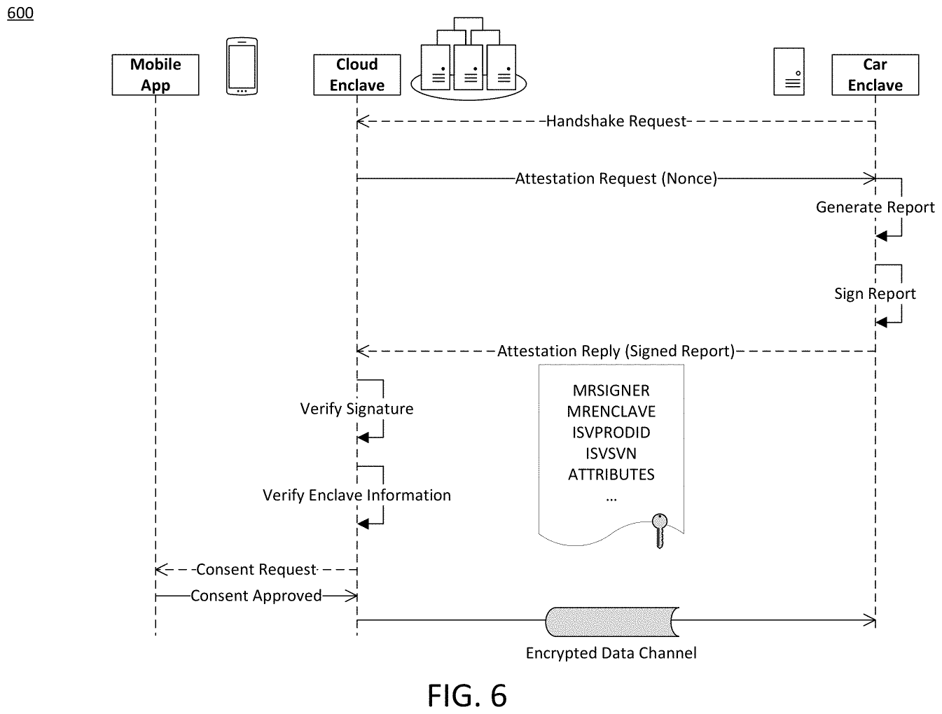

Turning now to FIG. 6, the vehicle enclave is initiated, which triggers a data transmission to the cloud enclave. The data transmission as shown in FIG. 6 is any suitable type of handshake request that is transmitted by a suitable component identified with the vehicle (such as one or more transceivers) to the cloud enclave in accordance with any suitable communication protocol, and starts the process of creating another secured and encrypted communication channel between the vehicle environment and the cloud environment. This data transmission, as well as the subsequent functions performed by the vehicle identified with the vehicle environment as discussed herein, which include the receipt and storage of the personalized machine learning training model, may be implemented via one or more processors identified with the vehicle executing the computer-readable instructions identified with the personalization module 209.

As discussed above with respect to the creation of the encrypted communication channel between the user environment and the cloud environment, the cloud enclave transmits, in response to the handshake request, an attestation request of the identity and integrity state of the vehicle enclave, i.e. a request for a quote for metadata to be included in a subsequent data transmission represented in FIG. 6 as the attestation reply, and further requests user confirmation before proceeding. In other words, one or more processors identified with the computing devices 206 in the cloud environment respond to the handshake request via execution of the computer-readable instructions identified with the personalization module 207.

At this point, the cloud enclave requests consent of the user 204 for the vehicle to receive the personalized machine learning trained model via the encrypted communication channel and execute the personalized machine learning trained model. This may be implemented via the cloud enclave transmitting any suitable type of consent request to the UE 202, which may comprise a data transmission in accordance with any suitable communication protocol. For the user 204 to approve this consent request, fingerprints of the vehicle enclave (such as predetermined images known to the user 204) may be shown in a display in the vehicle environment such as an in-vehicle screen, and the user 204 is then invited (such as via a prompt provided on the UE 202) to verify these fingerprints via interaction with the UE 202.

Assuming that the user 204 provides this consent via interaction with the UE 202, this causes the computing device(s) 206 to establish trust between the vehicle and the cloud as a result of the attestation process in a similar manner as discussed above with respect to the user environment and the cloud environment. That is, the computing device(s) 206 establish an encrypted communication channel between the cloud enclave and the vehicle enclave using the attestation request initiated by the cloud enclave. Moreover, upon the user 204 providing the consent, the execution of the personalized machine learning trained model (i.e. NN′ in this scenario) in the vehicle enclave is authorized via verification of the fingerprint using the UE 202 to authenticate and authorize the request.

The cloud enclave now encrypts the personalized machine learning model (such as NN′) with the public part of a key pair, which is only accessible in the vehicle enclave execution context. Once encrypted in this manner, the cloud enclave (via the one or more computing devices 206) transmits the encrypted personalized machine learning trained model NN′ to the vehicle enclave. As noted above for the cloud environment, the vehicle enclave likewise implements any suitable type of “Secret Sealing” functionality to only disclose the decryption key on that specific vehicle enclave, which is protected in the secured portion of the memory guarded by the vehicle processor. As discussed herein with reference to the cloud enclave, the encrypted personalized machine learning trained model NN′ may be stored in an unsecured portion of memory identified with the vehicle enclave but be executed in decrypted form within the vehicle enclave, thus maintaining confidentiality of the decrypted contents of the personalized machine learning trained model NN′. In other words, the one or more processors of the vehicle are configured to execute the instructions identified with the personalization module 209 to store the encrypted personalized machine learning trained model in the vehicle memory conditioned upon approval of the consent request transmitted from the cloud enclave to the UE 202.

The one or more processors of the vehicle may then decrypt the encrypted personalized machine learning trained model using a decryption key that is stored in a secure location of the memory protected by the vehicle processor, and then store the decrypted personalized machine learning trained model in the secure location of the memory protected by the vehicle processor. In this way, only the specific vehicle enclave that established trust with the cloud enclave may decrypt the personalized machine learning trained model NN′ and load the personalized machine learning trained model for execution.

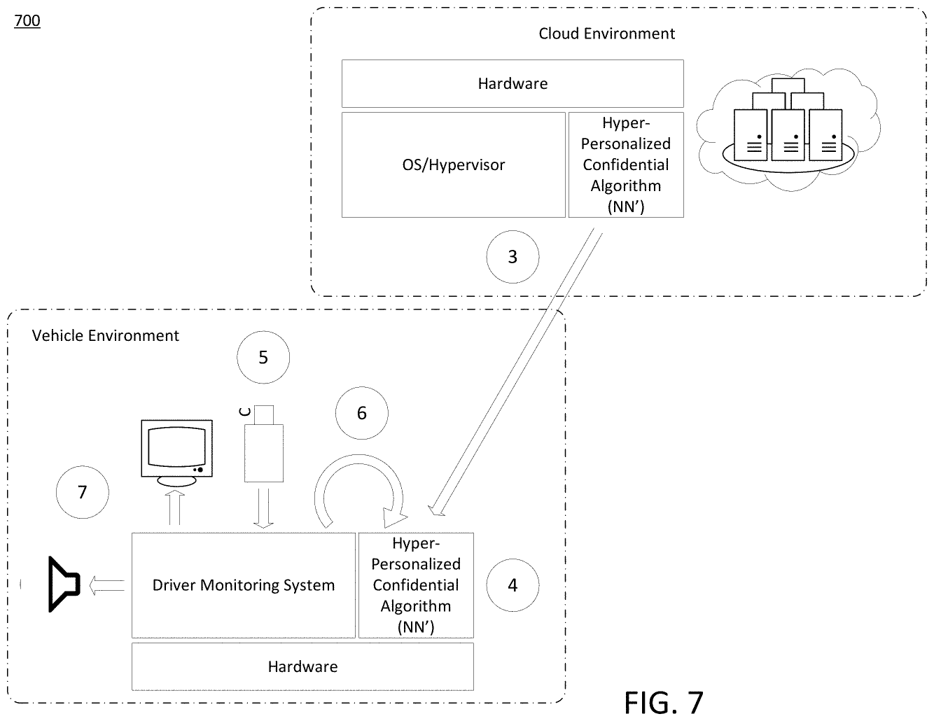

This process is further illustrated in detail in FIG. 7. That is, the personalized machine learning trained model NN′ is decrypted using the decryption key as noted above for the cloud enclave, and the decrypted personalized machine learning trained model NN′ is stored in the secured area of memory guarded by the vehicle processor. Stage 5 includes the DMS 208 capturing vehicle camera frames, whereas stage 6 includes the DMS 208 accessing the personalized machine learning trained model NN′ by performing the relevant API calls to transmit the vehicle's camera frames to be processed by NN′ as part of the drowsiness detection algorithm in this scenario. Stage 7 includes the execution of the DMS 208 using the personalized machine learning trained model NN′ to generate appropriate alerts based upon a detected level of drowsiness of the driver. However, the drowsiness level is now more accurate as the specific anatomy and features of the user 204 are now considered. Moreover, no personal data is left unencrypted in any of the untrusted locations of memory (i.e. not in the cloud environment and not in the vehicle environment). Now, the driving experience is more pleasant, as no annoying alarms are trigged, and the accuracy of the drowsiness level detection algorithm has improved.

Once the personalized machine learning trained model is stored in the cloud enclave of the cloud environment, the techniques disclosed herein facilitate the execution of the personalized machine learning trained model for the user 204 in any vehicle environment, i.e. for any suitable number of vehicles, regardless of whether such vehicles are owned by the user 204. The use of such techniques for vehicles not owned by the user 204 may be particularly useful when a vehicle identified with the vehicle environment is associated with a rented vehicle that includes the aforementioned DMS functionalities, and which may be powered by hardware technology to run confidential workloads as discussed herein.

To do so, the user 204 may repeat the process of bringing the UE 202 proximate to the IVI, display, etc. of the vehicle environment of the vehicle that is to be authorized for use of the personalized machine learning trained model. That is, and as discussed above with respect to FIG. 2, the user 204 may use the UE 202 to communicate with the DMS 208 by bringing the UE 202 in close proximity of the vehicle identified with the DMS 208 to establish a handshake between the UE 202 and the DMS 208 (which in this scenario is a different vehicle than discussed above). This triggers the hardware of vehicle to fetch the personalized machine learning trained model stored in the cloud enclave, which is implemented via the communication and attestation process discussed herein with reference to FIG. 6. After proper authorization of the vehicle enclave (attestation and user authentication and authorization using the consent request/approval communications as shown in FIG. 6), the cloud environment transmits (via the computing devices 206) the personalized machine learning trained model to the vehicle DMS 208, which deploys and decrypts the personalized machine learning trained model in the vehicle enclave (i.e. the secure or vehicle processor-protected portion of memory). The vehicle may then execute the DMS 208, which consumes the personalized machine learning trained model using the same API definition described above, thereby facilitating the use of the personalized machine learning trained model for the user 204 in that particular vehicle.

Continuing the above scenario, it is desirable for only authorized vehicles to execute the personalized machine learning trained model. Thus, after the user 204's trips end, the user 204 returns the vehicle, etc., the user 204 may once again use the UE 202 to interface with the vehicle as described herein (such as via NFC, Bluetooth, etc.). This communication may trigger the vehicle to deauthorize the vehicle enclave. Of course, this process may additionally or alternatively be automated based upon any other suitable conditions such as the rental period expiring, after a predetermined time period such as every 24 hours, etc. This deauthorization process may be implemented using an authorization list that is maintained in the cloud enclave or other suitable memory location accessible to the computing devices 206 in the cloud environment. This list may be modified to add approved vehicles based upon the aforementioned authorized communications between the user 204 and the DMS 208, which triggers the attestation process described herein with reference to FIG. 6. The deauthorization process operates to delete the personalized machine learning trained model from the vehicle cloud enclave and delete the vehicle from the approval list, thereby preventing future access of the personalized machine learning trained model from the cloud enclave without the user 204 initiating the authorization and attestation process for that specific vehicle. Thus, the cloud enclave only grants access to the personalized machine learning trained model for vehicles identified with this approved list, and only when the user 204 authorizes such use.

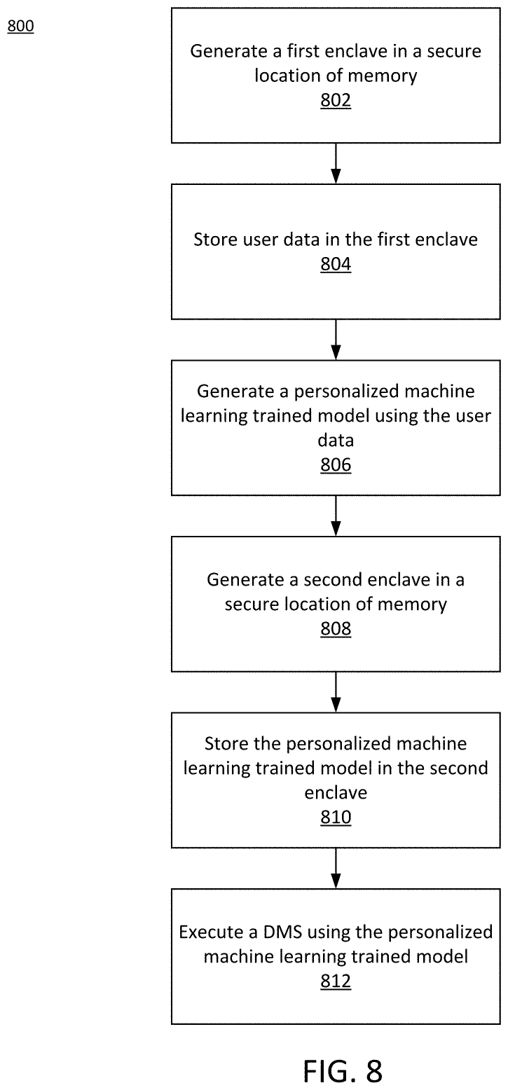

FIG. 8 illustrates a process flow, in accordance with the present disclosure. With reference to FIG. 8, the flow 800 may be a computer-implemented method executed by and/or otherwise associated with one or more processors (processing circuitry) and/or storage devices. These processors and/or storage devices may be associated with one or more computing components identified with a cloud environment (such as the computing devices 206 executing computer-readable instructions identified with the personalization module 207), a vehicle environment (such as the hardware and/or DMS 208 as shown in FIG. 2 executing the instructions identified with the personalization module 209), and/or a user environment (such as the UE 202 executing a local application or “app”), and may be implemented in combination and/or shared among one or more of these computing components in various environments as discussed herein.

The one or more processors identified with one or more of the computing components in various environments as discussed herein may execute instructions stored on other computer-readable storage mediums not shown in the Figures (which may be locally-stored instructions and/or as part of the processing circuitries themselves). The flow 800 may include alternate or additional steps that are not shown in FIG. 8 for purposes of brevity, and may be performed in a different order than the steps shown in FIG. 8.

Flow 800 may begin when one or more processors generate (block 802) a first enclave in a secure portion of memory. This enclave may be identified with the cloud environment as discussed herein with reference to FIG. 2, which may be instantiated for use by the one or more computing devices 206 via execution of the instructions identified with the personalization module 207.

Flow 800 may include one or more processors storing (block 804) user data in the first enclave. This may include receiving user data such as images, sensor data, metadata, etc., from the UE 202 or other suitable device via an encrypted data channel. The user data may be received in this manner using an attestation and verification process as discussed herein with reference to FIG. 3. Again, this may be facilitated via execution of the instructions identified with the personalization module 207 by the computing devices 206.

Flow 800 may include one or more processors generating (block 806) a personalized machine learning trained model using the user data. As noted above, this may include modifying an original machine learning trained model with the user data to generate a personalized machine learning trained model for the user identified with the user data. The generation of the personalized machine learning trained model may be implemented via execution of the instructions identified with the personalization module 207 by the computing devices 206.

Flow 800 may include one or more processors generating (block 808) a second enclave in a secure portion of memory. This enclave may be identified with the vehicle environment as discussed herein with reference to FIG. 2, which may be instantiated for use by one or more vehicle processors identified with the vehicle that implements the DMS 208 (e.g. via the one or more vehicle processors executing the instructions identified with the personalization module 209).

Flow 800 may include one or more processors storing (block 810) the personalized machine learning trained model in the second enclave. This may include receiving the personalized machine learning trained model in an encrypted form from the cloud enclave (one or more computing devices 206) or other suitable device via another encrypted data channel, which is then stored in the vehicle enclave as an encrypted personalized machine learning trained model. The encrypted personalized machine learning trained model may be received in this manner using an attestation and consent-authorization process as discussed herein with reference to FIG. 6. This may be facilitated via the one or more vehicle processors executing the instructions identified with the personalization module 209.

Flow 800 may include one or more processors executing (block 812) the personalized machine learning trained model stored in the second enclave. This may include decrypting the personalized machine learning trained model using a decryption key using confidential computing techniques, as discussed herein. Once decrypted, the personalized machine learning trained model may be consumed by the vehicle DMS through the API definition as discussed herein. The description and execution process may again be performed as a result of the one or more vehicle processors executing the instructions identified with the personalization module 209.

Again, the scenario described in this Section uses a drowsiness detection functionality of the DMS 208 as a prototypical scenario for the sake of simplicity. The techniques described throughout this Section are not limited to this specific functionality, and artificial intelligence (AI) or software components that require personal identifiable data to function properly may be implemented in accordance with these techniques and consumed by any suitable type of DMS through the API definition as discussed herein.

Furthermore, and as noted herein, although a cloud environment is described, this is only one possible implementation of the confidential storage used to securely train and store the personalized machine learning trained model. Any suitable equivalent mechanisms may be implemented for this purpose of re-training and storing the personalized machine learning trained model. This may include other components identified with the user environment (such as the UE 202), or the vehicle environment (such as the vehicle hardware), to re-train the machine learning trained models and transmit the personalized machine learning trained models to the vehicle enclave as part of a suitable attestation sequence.

Still further, although the techniques discussed throughout this Section primarily describe mechanisms to protect data identified with the user 204 when identified with the driver of a vehicle, these techniques may be expanded to the user 204 being any suitable occupant of the vehicle or other users not shown in the Figures for purposes of brevity.

Also, the data collection for re-training of the original machine learning trained model as discussed herein relies on a trusted device owned by the user 204 for collecting the user data (images, metadata, etc.). However, the user data may additionally or alternatively include any other suitable user data acquired from any suitable data source, such as vehicle sensors (cameras, microphones, etc.), which may be identified with the DMS 208 or other suitable portions of the vehicle. In such a scenario, the communications between the sensor and the components of the DMS 208, which capture and transmit the data to the re-training environment (such as the cloud environment) needs to be confidential as well. Thus, in such a scenario the attestation requirements between the relevant enclaves as discussed herein (such as the vehicle and cloud enclaves) may be repeated. The use of an attestation sequence in this manner ensures that no personal identifiable information is left outside of the secure environment in which the user's data is otherwise unprotected or prone to being compromised.

General Operation of a Computing Device

A computing device is provided. With reference to FIG. 2 and the cloud environment, the computing device includes a memory configured to store computer-readable instructions, and a processor configured to execute the computer-readable instructions to cause the computing device to: generate an enclave that is executed in a secure location of the memory and is protected by the processor; store user data received via an encrypted communication channel established between the enclave and a user equipment (UE) in the secure location of the memory as part of a training dataset; generate a machine learning trained model using the training dataset; and transmit the machine learning trained model to a vehicle that utilizes the machine learning trained model as part of a driver monitoring system (DMS). The user data comprises images of a user identified with a driver of the vehicle that utilizes the DMS. In addition or in alternative to and in any combination with the optional features previously explained in this paragraph, the processor is configured to execute the computer-readable instructions to generate the machine learning trained model by re-training a previously-trained machine learning trained model using the training dataset. In addition or in alternative to and in any combination with the optional features previously explained in this paragraph, the processor is configured to execute the computer-readable instructions to encrypt the machine learning trained model with a key that is stored in the secure location of the memory to generate an encrypted machine learning trained model. In addition or in alternative to and in any combination with the optional features previously explained in this paragraph, the encrypted machine learning trained model is stored in a portion of the memory other than the secure location. In addition or in alternative to and in any combination with the optional features previously explained in this paragraph, the processor is configured to execute the computer-readable instructions to cause the computing device to establish the encrypted communication channel via an attestation procedure performed with the UE. In addition or in alternative to and in any combination with the optional features previously explained in this paragraph, the processor is configured to execute the computer-readable instructions to cause the computing device to establish a further encrypted communication channel between the computing device and the vehicle using an attestation request that is initiated by the computing device, and to transmit the encrypted machine learning trained model to the vehicle via the further encrypted communication channel.

General Operation of a Vehicle

A vehicle is provided. With reference to FIG. 2 and the vehicle environment, the vehicle includes a memory configured to store computer-readable instructions; and a processor configured to execute the computer-readable instructions to cause the vehicle to: generate a vehicle enclave that is executed in a secure location of the memory protected by the processor; establish an encrypted communication channel between the vehicle enclave and a cloud enclave associated with a computing device; store an encrypted machine learning trained model received from the cloud enclave via the encrypted communication channel in the memory, the encrypted machine learning trained model being generated via the computing device using a training data set that includes user data identified with the vehicle; and execute a driver monitoring system (DMS) using the encrypted machine learning trained model. The user data comprises images of a user identified with a driver of the vehicle that utilizes the DMS. In addition or in alternative to and in any combination with the optional features previously explained in this paragraph, the processor is configured to execute the computer-readable instructions to decrypt the encrypted machine learning trained model using a decryption key that is stored in the secure location of the memory, and to store the decrypted machine learning trained model in the secure location of the memory. In addition or in alternative to and in any combination with the optional features previously explained in this paragraph, the encrypted communication channel is established in response to a handshake request transmitted to the cloud enclave that is initiated by the vehicle. In addition or in alternative to and in any combination with the optional features previously explained in this paragraph, the processor is configured to execute the computer-readable instructions to cause the vehicle to store the encrypted machine learning trained model in the memory conditioned upon approval of a consent request transmitted from the cloud enclave to a user equipment (UE). In addition or in alternative to and in any combination with the optional features previously explained in this paragraph, the vehicle may further include a sensor configured to acquire further user data, and the encrypted machine learning trained model is generated via the computing device using the training data set that includes the user data and the further user data.

General Operation of a Computer-Readable Medium

A computer-readable medium is provided. With reference to FIG. 2 and the cloud environment, the computer-readable medium has instructions stored thereon that, when executed by a processor identified with a computing device, cause the computing device to: generate an enclave that is executed in a secure location of memory that is protected by the processor; store user data received via an encrypted communication channel established between the enclave and a user equipment (UE) in the secure location of the memory as part of a training dataset; generate a machine learning trained model using the training dataset; and transmit the machine learning trained model to a vehicle that utilizes the machine learning trained model as part of a driver monitoring system (DMS). The user data comprises images of a user identified with a driver of the vehicle that utilizes the DMS. In addition or in alternative to and in any combination with the optional features previously explained in this paragraph, the instructions, when executed by the processor, cause the computing device to generate the machine learning trained model by re-training a previously-trained machine learning trained model using the training dataset. In addition or in alternative to and in any combination with the optional features previously explained in this paragraph, the instructions, when executed by the processor, cause the computing device to encrypt the machine learning trained model with a key that is stored in the secure location of the memory to generate an encrypted machine learning trained model. In addition or in alternative to and in any combination with the optional features previously explained in this paragraph, the encrypted machine learning trained model is stored in a portion of the memory other than the secure location of the memory. In addition or in alternative to and in any combination with the optional features previously explained in this paragraph, the instructions, when executed by the processor, cause the computing device to establish the encrypted communication channel via an attestation procedure performed with the UE. In addition or in alternative to and in any combination with the optional features previously explained in this paragraph, the instructions, when executed by the processor, cause the computing device to establish a further encrypted communication channel between the computing device and the vehicle using an attestation request that is initiated by the computing device, and to transmit the encrypted machine learning trained model to the vehicle via the further encrypted communication channel.

Section II—Techniques for Driver Monitoring System (DMS) Transparency and Opt-out

Passengers of vehicles, particularly autonomous vehicles, are exposed to extensive monitoring by different sensors, which may include sensors identified with DMS as noted herein or other suitable in-vehicle monitoring systems. As a result, the scope of applications for in-vehicle monitoring ranges from personal identification of driving style to actions and behavior inside the vehicle. But not all of these use cases are required to ensure the safety of passengers, and are instead may be used for convenience, statistical, or marketing purposes. In the light of data privacy efforts, it is desirable to provide the occupants with this information as well as providing the option to deactivate non-essential monitoring functions, such as by providing vehicle occupants the option to switch to less invasive monitoring techniques (such like LIDAR/depth sensing versus the use of RGB/vision-based sensing like cameras). If these options are not given to occupants, there is a chance that occupants might resort to vandalism to prevent being monitored, especially in public vehicles like robo-taxis.

This Section is directed to addressing such privacy issues related to the collection of sensor data by allowing occupants to understand the scope of the monitoring being done, and providing an intuitive interface to disable certain monitoring functions, such as those that are not safety relevant or that use personalized data. In addition, some services can be activated that use sensors for health checks or interaction with the vehicle's multi-media system. The techniques described in this Section also anticipate future privacy laws concerning monitoring of personal activity in vehicles.

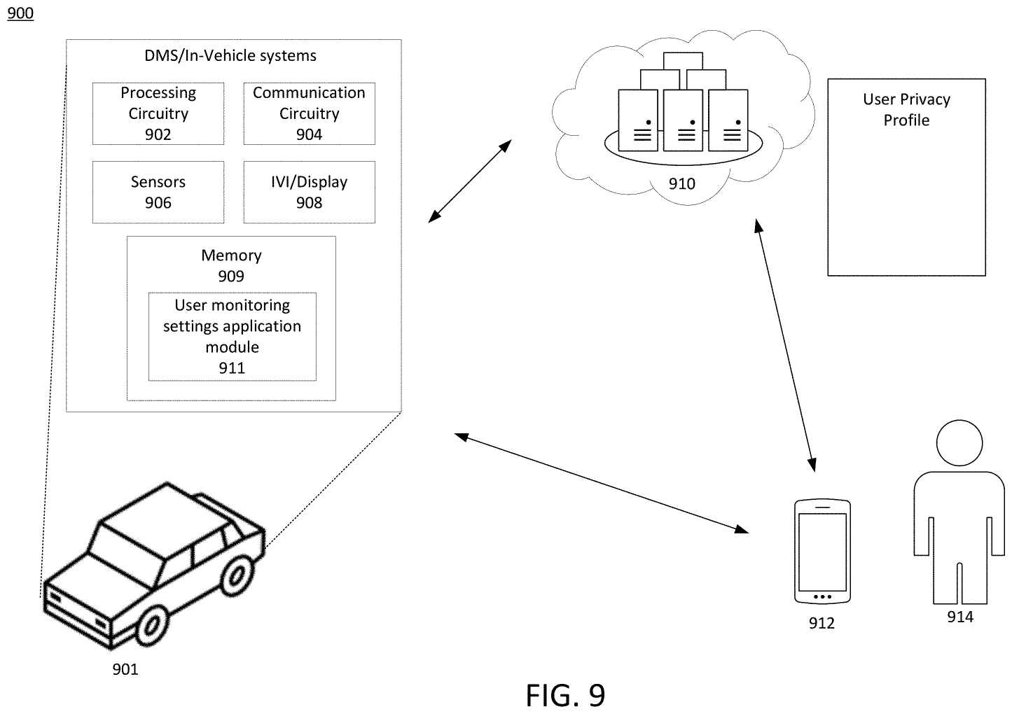

FIG. 9 illustrates an example architecture for providing transparency of collected sensor data, in accordance with the disclosure. An example architecture 900 is shown in FIG. 9, which enables a user 914 to control how sensor data collected by the vehicle 901 is utilized, displayed, and/or shared as part of the vehicle's operation, as further discussed herein. As shown in FIG. 9, the architecture 900 includes a vehicle 901, a UE 912, and one or more computing devices 910. The vehicle 901 may include processing circuitry 902, communication circuitry 904, sensors 906, an IVI/display 908, and a memory 909.

The vehicle 901 may be identified with any suitable type of vehicle, such as a personal vehicle, a rental vehicle, or a for-hire vehicle such as a rideshare vehicle, a robo-taxi, etc. The vehicle 901 may be partially or fully autonomous, or may alternatively be a standard (i.e. non-autonomous) vehicle. The vehicle 901 may include additional, fewer, or alternate components than those shown in FIG. 9.

The processing circuitry 902 may be implemented as any suitable number and/or type of processors such as one or more on-vehicle processors, graphics processors, a central processing unit (CPU), support circuits, digital signal processors, integrated circuits, or any other types of devices suitable for running applications and for data processing and analysis. The processing circuitry 902 may collectively include any suitable number and/or type of vehicle processors that may implement the functionality of the various techniques as described in this Section. The processing circuitry 902 may be identified with a DMS or other suitable in-vehicle monitoring systems and thus facilitate in-vehicle monitoring functionality as discussed herein. The vehicle 901 may also include any suitable type of memory 909, which stores data and/or instructions, such as instructions executable by the processing circuitry 902. The memory can be any well-known volatile and/or non-volatile memory, including read-only memory (ROM), random access memory (RAM), flash memory, a magnetic storage media, an optical disc, erasable programmable read only memory (EPROM), and programmable read only memory (PROM). The memory can be non-removable, removable, or a combination of both.

The sensors 906 may be implemented as any suitable number and/or type of sensors that may be utilized by the vehicle 901 to perform in-vehicle monitoring-based or other suitable functions. This may include DMS-related functions such as monitoring occupants of the vehicle, or other suitable monitoring-based functions which may be dependent upon the particular vehicle 901. That is, the sensors 906 may be implemented as one or more in-cabin cameras and/or microphones configured to capture images, video, and/or audio of the occupants of the vehicle for DMS-related functions, for safety-related functions, to provide security, etc. The sensors 906 may thus include, in addition to or as an alternative to such cameras and/or microphones, any other suitable type of sensor device that may be used to collect data regarding a state of the vehicle 901 and/or occupants of the vehicle 901, such as LIDAR, RADAR, infrared sensors, accelerometers, gyroscopes, compasses, barometers, vibrational sensors, thermal sensors, biometric sensors, etc.

The vehicle 901 may further include communication circuitry 904, which may be implemented as any suitable combination of hardware and/or software components to facilitate the vehicle 901 communicating with the computing devices 910 and/or the UE 912. The communication circuitry 904 may include any suitable number and/or type of transmitters, receivers, transceivers, etc., which enable the vehicle 901 to transmit and/or receive data from the computing devices 910, the UE 912, and/or other suitable components not shown in the Figures in accordance with any suitable number and/or type of communication protocols.

The computing devices 910 may be implemented as any suitable type of computing devices remote from the UE 912 and the vehicle 901, such as servers, computers, etc. The computing devices 910 may be configured to operate in any suitable type of computing arrangement to communicate with the UE 912 and/or the vehicle 901, and to store user privacy profiles that identify or otherwise describe how sensor data may be utilized by the vehicle 901, as further discus sed herein.

The UE 912 may be identified with a user 914. The UE 912 may be implemented as any suitable type of electronic device configured to perform wireless communications, such as a mobile phone, computer, laptop, tablet, wearable device, etc. The UE 912 is configured to store and execute one or more applications, such as mobile “apps” that facilitate a user creating monitoring settings and/or a user privacy profile, either or both of which may be transferred and stored in the computing devices 910. The vehicle 901, the UE 912, and the computing devices 910 are configured to communicate with one another using any suitable number and/or type of communication protocols to exchange data between one another uni-directionally and/or bi-directionally.

As further discussed throughout this Section, the techniques discussed enable users to control the type and/or operational aspects of sensors that are used for in-vehicle monitoring among different vehicles on a per-user and per-vehicle basis, thereby providing users with transparency with respect to the type and use of sensor that may collect images or other personally-identifiable or private information about the user. In other words, and as shown in FIG. 9, users may create monitoring settings and/or a user privacy profile via the UE 912, which is/are then stored online (such as in the computing devices 910). In any event, the monitoring settings (which may form part of or otherwise be associated with the user privacy profile) may define user preferences with respect to the collection of sensor data for in-vehicle monitoring systems. These monitoring settings may define a preference of some sensors over others, specific types of operating modes or sensor usage that the user may opt in or out of, user preferences regarding how data is shared between third parties, preferences regarding data retention time periods, sensor operation settings, etc.

That is, in addition to or instead of defining specific sensors that may be used to collect data, the monitoring settings may specify other types of user preferences such as a time frame over which collected sensor data may be maintained and the limitations regarding how collected sensor data may be shared outside of a vehicle. Such monitoring settings may indicate a temporal scope for which the collected sensor data may be used, i.e. only during the presence of the user, different timespans after each trip has ended, etc. The monitoring settings may further include specifying only in-vehicle sensor data usage, in which case the vehicle 901 may not transmit or share the collected sensor data with other parties or other computing devices external to the vehicle 901.

In any event, the techniques described in this Section enable the creation, storage, and application of monitoring settings, which may be identified by a generated user privacy profile or via other means as discussed in further detail in this Section. The monitoring settings may indicate a user's corresponding selection of sensors that are authorized to collect sensor data in accordance with an in-vehicle monitoring system during vehicle operation. The selection and/or subsequent application of these monitoring settings by a respective vehicle thus results in that vehicle executing an in-vehicle monitoring system (such as a DMS or other suitable in-cabin monitoring systems as discussed herein) to collect sensor data in a manner as indicated by the monitoring settings during vehicle operation.

As further discussed in this Section, the vehicle 901, which may correspond to any suitable type of vehicle, may store computer-readable instructions in the memory 909 such as the user monitoring settings application module 911. The processing circuitry 902 may thus execute these instructions to perform the various techniques as discussed herein, which may include receiving the monitoring settings and/or user privacy profile via communications with any suitable components (such as the computing devices 910 and/or the UE 912), and identifying or otherwise mapping the sensor selections (i.e. sensor authorizations) and/or sensor settings indicated by the monitoring settings to the existing in-vehicle sensors to facilitate execution of the in-vehicle monitoring systems in accordance with those sensors and sensor settings that are identified/authorized by the monitoring settings. Furthermore, and as noted in further detail in this Section, the processing circuitry 902 may execute the instructions stored in the user monitoring settings application module 911 to resolve and/or modify the user monitoring settings with the actual sensors available in a specific vehicle. Still further, the processing circuitry 902 may execute the instructions stored in the user monitoring settings application module 911 to cause the vehicle 901 to transmit data to a suitable computing device (such as the UE 912) to convey information indicative of which sensors in the vehicle are being used to collect the sensor data during, before, or after executing the in-vehicle monitoring system.

To do so, the monitoring settings may be established by recognizing different use cases, which are clustered or grouped according to their relevance for safety and the need for individual types of sensor data such as acquiring the user's face, voice, fingerprint, or other biometric data. Thus, the user may create personalized monitoring settings using any suitable computing device, such as the UE 912, which may execute an application locally or receive data from one or more other computing devices (such as the computing devices 910) to present a graphical user interface (GUI) to the user 914 for this purpose. The GUI may display the various levels of in-vehicle monitoring inside of vehicle via a catalog of features that are grouped into various use cases, which may allow the user 914 to transparently visualize the impact of the collection of different types of sensor data and the impact and usage of each specific type of sensor data.

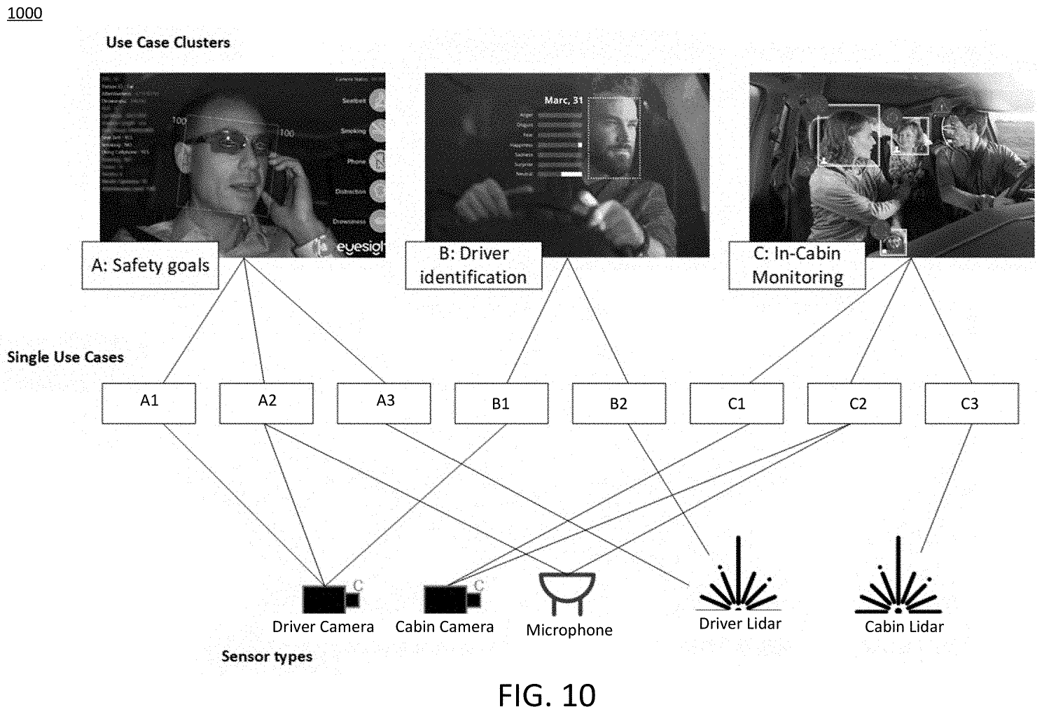

FIG. 10 illustrates an example of grouping of in-vehicle monitoring features by use case, in accordance with the disclosure. The grouping as shown in FIG. 10 may be displayed to a user to enable the user to visualize the use of sensor data for each use case grouping, with three being shown in FIG. 10 as a non-limiting scenario. Each use case group is directed to a different goal that the in-vehicle monitoring system aims to achieve. That is, grouping A is directed to safety-related goals, grouping B is directed to driver identification features, and grouping C is directed to in-cabin monitoring features.

In other words, an interface may be provided to the user 914 to customize the monitoring settings. The monitoring settings may then be used to generate a user privacy profile that identifies these settings, although this is not necessary, as an interface may be provided to a user at any suitable time for the selection of the monitoring settings, and the user privacy profile need not be created in advance of the user riding in the vehicle 901 or, in fact, be created at all. That is, the user 914 may interact with the vehicle 901 via a display and/or via the UE 912 at the start of each trip to identify the monitoring settings as discussed throughout this Section. When a user privacy profile is used, the user privacy profile may advantageously be stored remote to the vehicle 901 in accordance with any suitable storage system (such as cloud storage, by the computing devices 910, etc.). Additionally or alternatively, the monitoring settings and/or user privacy profile may be stored or in or associated with a token, such as an NFC or radio frequency identification (RFID) tag, a smart card, etc., which may be reprogrammable by the user 914. Thus, the user interface as discussed herein may be implemented in the vehicle 901 and/or as a cloud-based platform that centrally stores the monitoring settings and/or user privacy profile, and which may support a mobile app that is executed by the UE 912 to enable the user 914 to view and modify the monitoring settings. The user interface may additionally convey to the user the current vehicle's sensing capabilities/regulation status, opt-in and opt-out status for sensor data collection, etc. during, before, or after riding in the vehicle 901.

In any event, the monitoring settings as discussed in this Section may be selected by the user 914 at any suitable time based upon the specific vehicle type, based upon the user's role when travelling in the vehicle 901, and/or any other suitable factors. Again, the creation of the monitoring settings and/or user privacy profile may be accomplished via interaction with any suitable user interface. Alternatively, this process may be partially or fully automated via the use of the generated user privacy profile, which may contain “global” monitoring settings that are defined for various user roles, vehicle types, use cases, etc. The use of the monitoring settings and/or user privacy profiles in this way not only provides transparency and offers privacy with respect to how sensor data is collected and used, it further advantageously enables better data quality for subsequent machine learning algorithms or segmentation of the vehicle interior into driver focused and in-cabin focused (apart from the driver).

That is, in various scenarios the user, the vehicle, accompanying monitoring settings, and/or accompanying user privacy profile may be identified via communications (such as NFC communications, Bluetooth communications, etc.) established between a device identified with the user (such as the UE 912 and user 914, a smart card, token, etc.) at the time of purchase of a privately-owned vehicle, at the time the vehicle is rented online or at the pickup office, inside the vehicle 901 visually and/or using audio, when a request is made online for a taxi or rental or provider, etc. In any event, the monitoring settings may be retrieved by the vehicle 901 in accordance with any suitable communication protocols, such as via communications with the UE 912 and/or the computing devices 910. Moreover, the specific type of vehicle may additionally or alternatively be conveyed to the computing devices 910 via the vehicle 901 and/or the UE 912, which may be the result of communications that are triggered upon the UE 912 performing any suitable type of communications with the vehicle 912, the user 914 using the UE 912 to request a robo-taxi or ridesharing service in which the type of vehicle 901 is known by the computing devices 910, etc.

Regardless of the means by which the vehicle 901 may obtain the monitoring settings, which again may be identified by the user and/or be associated with the user privacy profile, the vehicle 901 may apply the monitoring settings, which may be tailored to that specific vehicle type, the particular user, and the user's role while travelling in that vehicle. The application of the monitoring settings may thus include the processing circuitry 902 executing the instructions stored in the user monitoring settings application module 911 to read the user's monitoring settings with respect to the various use cases, sensor types, and/or sensor operation settings previously identified by the user 914 when the monitoring settings were created. The processing circuitry 902 may then map or correlate the current capabilities and/or sensors of the vehicle 901 with the monitoring settings such that the execution of the in-vehicle monitoring system operates in accordance with these settings. That is, the vehicle 901 may execute the in-vehicle monitoring system to collect sensor data using sensors in the vehicle that are mapped to sensors identified by the monitoring settings and operate (i.e. execute) the in-vehicle monitoring system using these sensors and any relevant sensor settings as indicated by the user privacy profile.

Thus, and referring now back to FIG. 10, the various use cases which may be presented to the user via a user interface as part of a catalog of use case scenarios includes three separate use case groups. The grouping A of use cases may correspond to safety-related functions performed by a DMS or other suitable in-vehicle monitoring system, which as noted in Section I may perform safety-related functions such as detecting if a driver is distracted while controlling the vehicle by monitoring gaze direction and hand activities, detecting if a driver is drowsy while controlling the vehicle by analyzing eyes and facial expressions, or performing such functions while the driver is currently not controlling the vehicle but when handing control from the vehicle back to the driver is imminent. Moreover, an in-vehicle monitoring system may perform monitoring for potential danger to all passengers, especially children, in case of an accident, monitor the health condition of the driver, monitor the emotional state of driver, detect violence, etc.

Grouping B may correspond to security features, such as identifying a driver using biometric sensor data, and grouping C may correspond to in-cabin monitoring features that are neither safety nor security relevant. The use cases in grouping C may include recognizing roles in the vehicle cabin, determining ownership of objects to persons, detecting forgotten objects, in-cabin interaction, monetization aspects, etc.

It is noted that some features for certain use cases may be mandatory for certain vehicle classes, and are thus not modifiable by the vehicle manufacturer, or may be required by law in a particular jurisdiction. However, some of features may be optional such as the monitoring of emotional state or health monitoring. The techniques disclosed in this Section may be applicable for the application and modification of sensor usage for in-vehicle monitoring systems to the extent that it is possible or legal to do so. Thus, the techniques described in this Section are directed to making vehicle monitoring transparent and allow users the option to disable features that may not be necessary, such as the aforementioned optional features for specific use cases.

The use case groupings A, B, and C as shown in FIG. 10 may be from among any suitable number of use cases, which may change as the technology evolves and/or different types of sensor data, features, etc. become available. Furthermore, the use cases may be further grouped based upon other features or goals such as convenience, acquiring additional information, performing quick health checks, etc. Each use case grouping is thus identified with a specific set of sensors associated with the in-vehicle monitoring system. That is, and as shown in FIG. 10, the use cases A1, A2, and A3 are each part of the safety goal use case grouping, the use cases B1 and B2 are part of the driver identification use case grouping, and the use cases C1, C2, and C3 are each part of the in-cabin monitoring use case grouping.

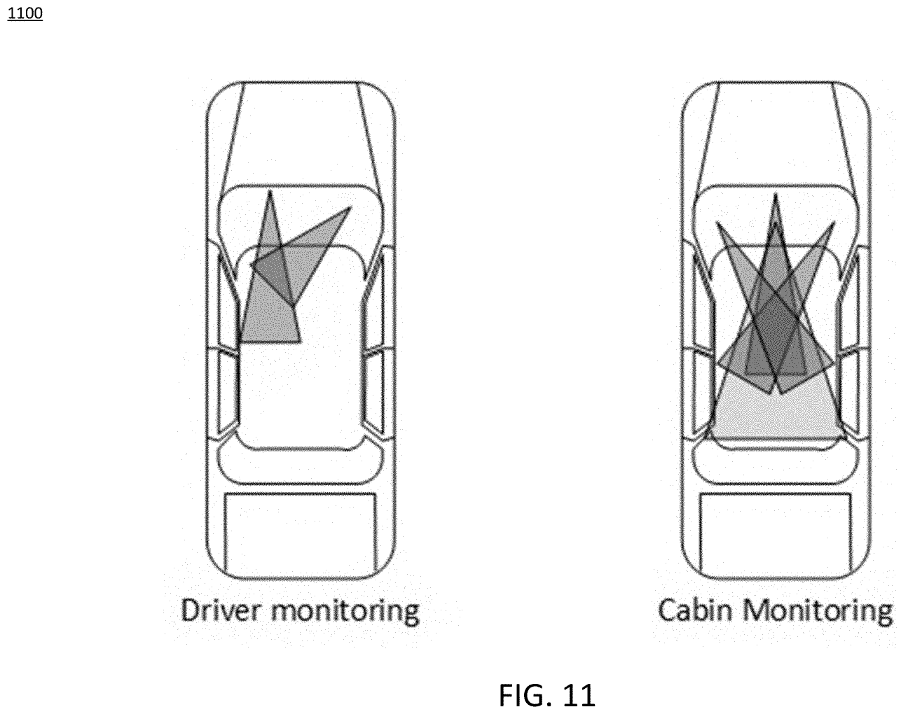

The monitoring settings, which may be defined as part of the user privacy profile, may enable a user to identify preferences with respect to sensor data collection in accordance with any suitable type of granularity, and thus any suitable number of use cases may be assigned within any suitable number of use case groupings. Each individual use case may also be correlated to the specific type of sensors and the sensor data collected by those sensors that function to achieve the desired goal for that use case. That is, and with continued reference to FIG. 10, the safety goal use case grouping A may achieve safety-related functionality with respect to monitoring the driver of a vehicle, but may use different combinations of sensors to achieve this goal. That is, the use cases A1 and B1 only use a driver-facing camera, the use case A2 uses a combination of the driver-facing camera and the microphone, whereas the use cases A3 and B2 use only driver-facing LIDAR. Moreover, the use cases C1 and C2 use in-cabin cameras, whereas the use case C3 only uses in-cabin LIDAR. FIG. 11 further demonstrates the usage of specific type of cameras that may be used in these different use cases to capture images of the driver in some use cases using the driver-facing cameras, and to capture images of all occupants of the vehicle in others via the use of the in-cabin camera(s).

Again, the use case clusters or groupings as shown in FIG. 10, together with their respective correlated sensors, may be displayed, listed, or otherwise conveyed to the user 914 via a user interface. The user 914 may then interact or otherwise select from among the individual use cases A1, A2, A3, B1, etc., to select monitoring settings. Although not all user options are shown in the Figures for purposes of brevity, this may include preferences to disable some entire use cases, to prioritize certain individual use cases within the use case groupings, to indicate a preference that certain use cases may be enabled, a preference regarding whether to be monitored based upon the user's role (such as not when the user is a passenger, but when the user is a driver), specific functionality or service(s) that are not desired and/or others that are preferred, etc.

It is noted that, due to the configuration of some vehicles, certain use cases, such as those directed to safety-based functionality, may not be able to be completely disabled. However, the user 914 may indicate a preference for certain use cases based upon the type of sensor data over others. That is, because the use case A3 uses only LIDAR versus the use cases A1 and A2, which use the driver-facing camera, the user 914 may prefer the use case A3 over the use cases Al and A2 if concerned about privacy. The user 914 may select or prioritize these preferences by interacting with an image displayed on the UE 912, the vehicle 901, or other suitable computing device, which may result in displayed image changing to convey the result of these preferences to the user. This may include the use of any suitable type of graphical indicators such as graying out use cases and accompanying sensors that are not preferred or otherwise unselected, displaying indications regarding the impact of such selections if a particular feature will become unavailable, displaying warnings regarding enhanced safety-related features being reduced in effectiveness, etc. Additionally or alternatively, a user may modify how a sensor collects data versus not collecting data whatsoever. In one scenario, a user may enable the use of driver- or in-cabin cameras for some use cases but do so with lower resolution settings.

Additionally or alternatively, to balance the use of non-safety related monitoring, the user interface may convey the consequences of opting out of such sensor data collection by identifying functionality that is no longer available when certain user selections are made, thereby allowing the user to make an informed decision. Again, some types of monitoring may be legally mandatory at certain times or in certain countries. Thus, the user interface will inform the user about such occasions.

As yet another option, the monitoring settings may define a user's preference for opting into sensor data collection for certain monetization incentives. This may include an indication that the user agrees to a specific set of sensor data collection for specific types of vehicles, services, and/or user roles (such as when riding as a passenger in a for-hire vehicle). The user may receive monetary benefits such as a reduced ride fare, coupons, etc., in exchange for opting-in to such sensor data collection. Other benefits that may be conveyed in exchange for opting-in to sensor data collection in various scenarios, which may be conveyed to the user via the use interface, may include fee health checks (using biometric sensor data collection), additional interaction with in-cabin functions, etc. Further scenarios include allowing a user to switch safety-critical features on or off in exchange for other considerations such as an increase in insurance premiums, reduced insurance benefits, increased trip fare, etc.

As further discussed throughout this Section, the application and use of monitoring settings in this way allows for real-time communication of ongoing sensor data collection and the purpose of sensor data collection for each user and vehicle in which that user's monitoring settings are applied. Therefore, a user may additionally or alternatively specify settings in the user privacy profile for selected functions or use cases that relate to the manner in which sensor data is collected and/or used. This may include specifying an anonymization of sensor data that is collected from specific sensor types and/or for specific use cases. As one non-limiting scenario, a user may specify monitoring settings indicating a preference for the use of anonymized images, an anonymized video stream, and/or anonymized audio data collected by driver-facing or in-cabin cameras that are used by the vehicle's machine learning algorithms.

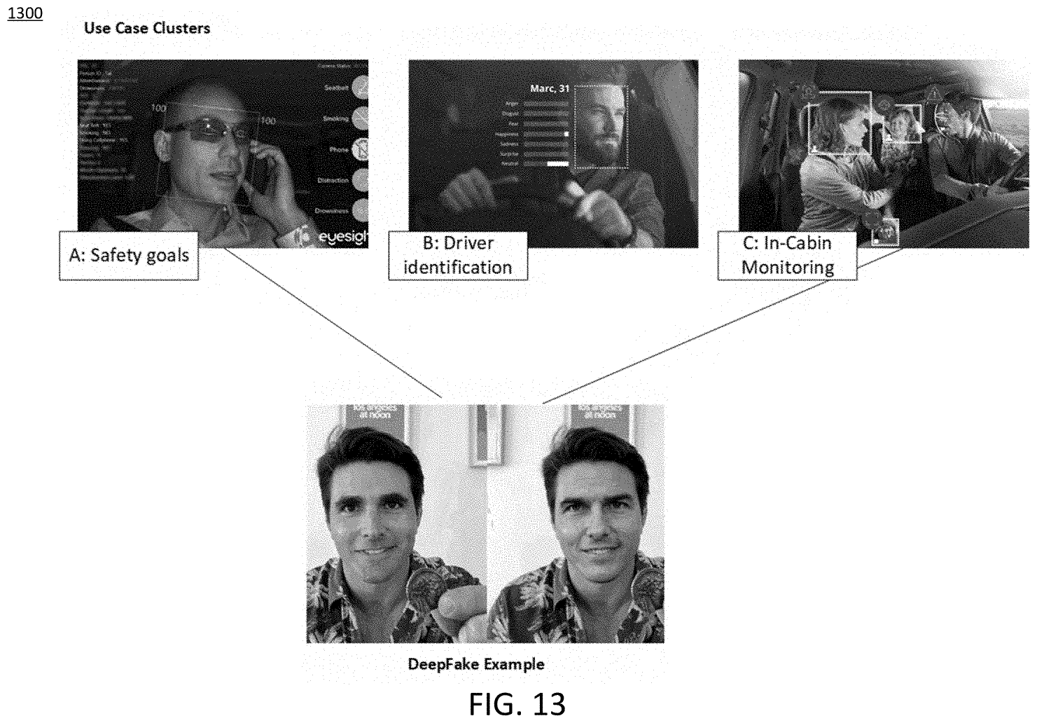

Continuing this scenario, techniques for achieving such anonymization may include the use of “DeepFakes,” which preserve primary facial features like facial expression or eye gaze for machine learning training purposes. Advantageously, a user may view (such as via the UE 912) the result of applying this selection and/or view a real time sensor data feed while the in-vehicle monitoring system is executed in accordance with the specific monitoring settings. A scenario in which such anonymization techniques are shown to the user in this manner is shown in FIG. 13. The use of anonymization in such a scenario may be realized using any suitable techniques, including known techniques.

In addition to the use case groupings as noted herein, the types of vehicles with respect to monitoring may also be grouped into any suitable number of classes, which may influence the relevance and/or availability of the various use cases as discussed further in this Section. These classes may include privately owned vehicles, which are primarily driven by the owner and related persons, rental vehicles that still require a human driver during some period of time, fully autonomous vehicles, etc. The vehicle 901 may thus map these monitoring settings by correlating the vehicle type of the vehicle 901 to the monitoring settings identified for that specific type of vehicle.

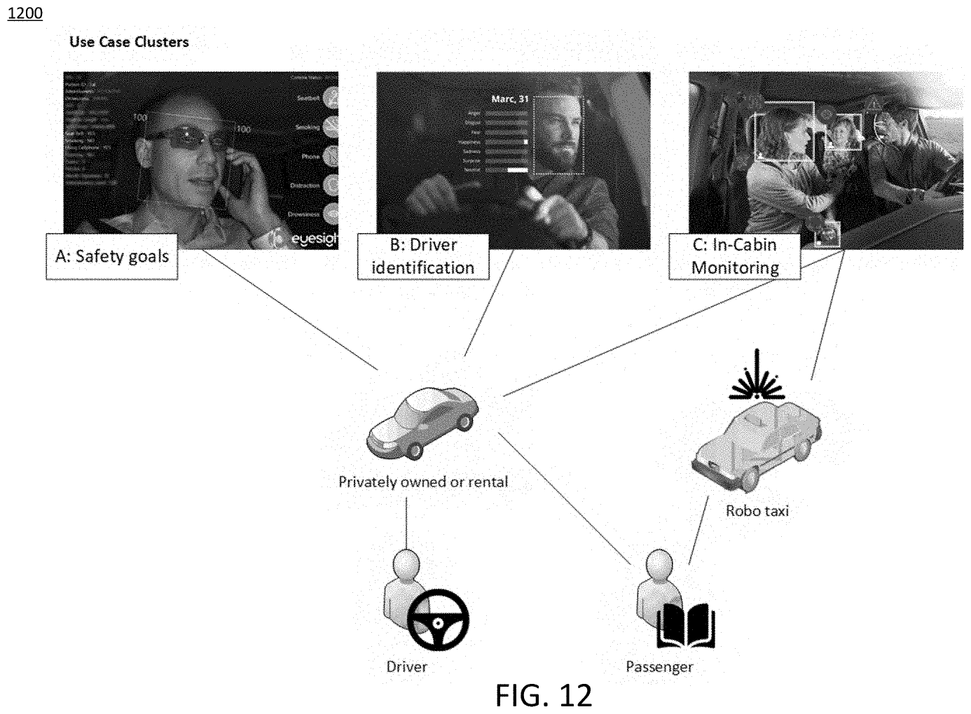

To facilitate the application of the monitoring settings, the roles of the passenger may also be mapped to use cases and to types of vehicles, as shown in further detail in FIG. 12. That is, a user may select a user role for each use case, and a user may thus identify monitoring settings for each of the individual use cases A1, A2, A3, B1, etc. by further specifying, for each use case, the user's preference based upon the user's role. In other words, the monitoring settings may reflect a further consideration of the type of vehicle and the user's role when driving in that type of vehicle to facilitate a user selection for the purpose of creating the monitoring settings. As shown in the two scenarios in FIG. 12, robo-taxis do not require a human driver and therefore the user's preferences in the user privacy profile are not relevant for the critical functions (use case grouping A), as this use case group does not include driver monitoring functionality in this scenario. However, the monitoring settings are relevant for privately owned cars and rental cars.

Thus, and as further discussed below in this Section, the monitoring settings may further contain user preferences with respect to the type of vehicle and/or the user's role in that vehicle. This may be the case when the user privacy profile is implemented that contains global monitoring settings of monitoring preferences of the user 914. The vehicle 901 may then map the monitoring settings to different sets of in-vehicle features for that particular type of vehicle based upon the user's current role for that vehicle. That is, when the user 914 is a passenger in the vehicle 901 and the vehicle is a privately-owned vehicle, the vehicle 901 may locally map the monitoring settings to disable the cabin-facing cameras. In another scenario, when the user 901 is a driver in the vehicle 901 and the vehicle 901 is a privately-owned vehicle, the vehicle 901 may locally map the monitoring settings to enable the driver-facing and the in-cabin facing cameras. In this way, a user privacy profile may ensure that the user's preferences with respect to data collection are maintained for different vehicle types, vehicle uses, and/or the role of the passenger while riding in different types of vehicles.

The user privacy profile may thus contain any suitable type of information regarding the user, as well as monitoring settings for specific use cases, vehicle types, settings with respect to how sensor data is collected and/or used, a selection of sensors that are authorized to collect sensor data in accordance with an in-vehicle monitoring system during vehicle operation, an indication of how authorized sensors may collect sensor data in accordance with an in-vehicle monitoring system during vehicle operation etc. The user privacy profile may be linked to a specific user who may be identified by a vehicle or other suitable computing device (such as the computing device 910), and which may convey the identity of the user and/or the user privacy profile to the vehicle 901 in any suitable manner.

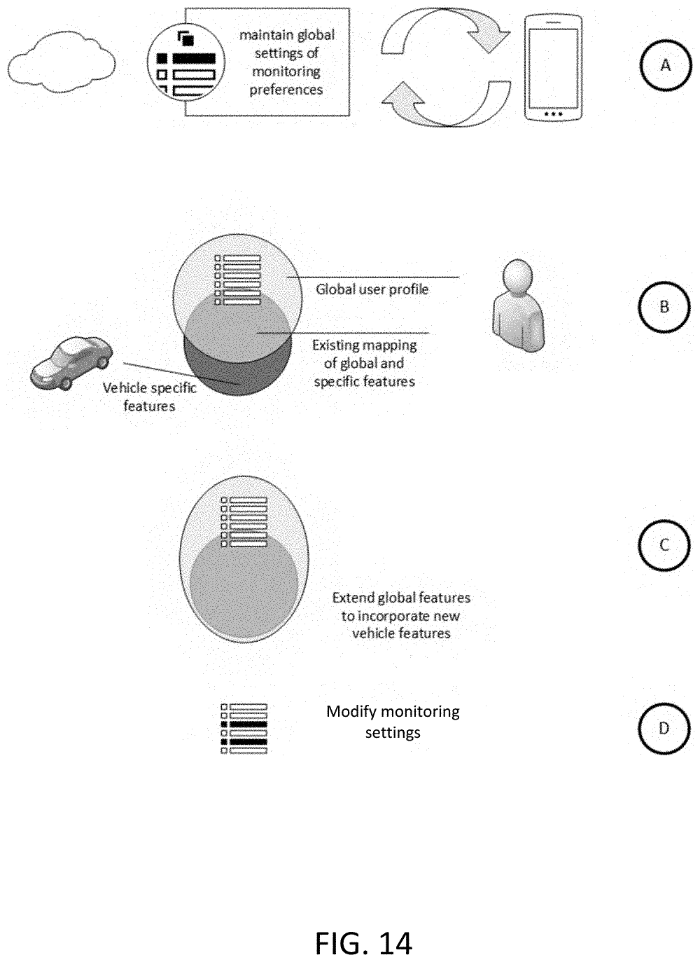

Again, the user privacy profiles may be generated and stored in a suitable storage location, which may include the monitoring settings and other information that may be defined by the user or other entity, as discussed throughout this Section. The user privacy profiles may include monitoring settings that may be applied to a wide variety of different vehicles that may be used (or be anticipated for use) by the user 914. As noted throughout this Section, the monitoring settings thus function to identify which sensors may be used by the vehicle 901 for in-vehicle monitoring, how sensor data is collected, how long data may be retained, whether the sensor data may be shared outside of the vehicle 901, etc., by mapping the preferences identified by the monitoring settings to the capabilities of the vehicle 901 at the time the user 914 rides in the vehicle 901. The monitoring settings may be mapped by the vehicle 901 in this manner by correlating the current vehicle type (rental vehicle, robo-taxi, personal vehicle, etc.), the user's role (such as driver vs. passenger) in that vehicle, and/or other suitable relevant information to the corresponding data identified by the monitoring settings. The process of mapping the monitoring settings to specific vehicles is further discussed below with reference to FIG. 14.

FIG. 14 illustrates a flow for user privacy profile management, in accordance with the disclosure. As noted in this Section, the user privacy profile may contain global monitoring settings for a particular user, which may specify monitoring settings for that user depending upon the particular vehicle, the user's role in each vehicle, or any other suitable type of information or conditions as specified by the user or other entity when the user privacy profile was created.

The user privacy profile may be centrally stored in a remote location, such as in the cloud as shown in FIG. 14 (‘A’), which may be identified with the computing devices 910 as discussed herein with reference to FIG. 9. Because the user privacy profile includes global monitoring settings, the user privacy profile is valid for any suitable number and/or type of vehicles. The user privacy profile may be accessed and managed (i.e. modified, deleted, etc.) using any suitable type of interface (such as a web-based interface) and accompanying computing device, such as the UE 912, the vehicle 901, etc.

Then, when using a specific vehicle, the monitoring settings in a user's privacy profile are applied to the monitoring features inside the vehicle (‘B’). As a result, the vehicle will execute the in-vehicle monitoring system to collect sensor data using sensors in the vehicle that are mapped to sensors identified by the monitoring settings associated with the user privacy profile, as discussed in this Section. Additionally, the vehicle may collect sensor data with the authorized sensors as indicated by the monitoring settings (such as by adjusting camera resolution settings, using anonymized data sources, etc.).

However, and as shown in FIG. 14, in many cases there will be no perfect match between the sensors in a particular vehicle and the sensors specified by the monitoring settings. In other words, the user privacy profile may contain monitoring settings that are not relevant for a specific vehicle, and likewise the vehicle may implement features that the user has not encountered before, and thus are not specified as part of the monitoring settings. In such a case, the vehicle (via the processing circuitry 902 executing the user monitoring settings application module 911) may map in-vehicle sensors and accompanying settings for the operation of those sensors using an intersection of both feature sets. That is, the vehicle may first map the sensors and accompanying sensor settings to those sensors that are specified in the monitoring settings, resulting in the vehicle adjusting the in-vehicle monitoring system to implement the specified sensors and otherwise operate as specified by the monitoring settings.

However, the user may then adjust the monitoring settings to incorporate the new vehicle features for that specific vehicle. To do so, the vehicle (via the processing circuitry 902 executing the user monitoring settings application module 911) may identify unmapped or otherwise unresolved sensors that are not accounted for in the monitoring settings (‘C’). In response, the user may utilize any suitable user interface to adjust the remaining vehicle specific features to his/her user privacy profile, which may be stored as a modified user privacy profile (‘D’). The modified monitoring settings may thus correspond to a further selection of the additional sensors in the vehicle that are authorized (or not authorized) to collect sensor data in accordance with the in-vehicle monitoring system during vehicle operation, as well as any accompanying sensor settings for these specified sensors if applicable. The user privacy profile may be modified over time for any suitable number of vehicles, vehicle types, user preferences, etc. In this way, the user privacy profile may maintain monitoring settings that are persistent across various types of vehicles that may be encountered by the user over time.

Once the modified user privacy profile is created in this way, the vehicle may receive the modified user privacy profile with the modified monitoring settings (such as via the UE 912 or the computing devices 910). In response, the vehicle 901 may execute the in-vehicle monitoring system to collect sensor data using sensors in the vehicle that are based upon the application of the modified monitoring settings associated with the modified user privacy profile.

In one scenario, this might include the user indicating a preference for using LIDAR versus driver-facing (image-based) cameras when the user initially creates the user privacy profile. However, a particular vehicle may not be equipped with in-cabin LIDAR sensors. Thus, the vehicle may transmit appropriate communications conveying the lack of LIDAR capabilities to the user (such as via communications transmitted to the UE 912), which are displayed to the user. In response, the user may indicate that (for this particular vehicle) the in-vehicle monitoring system is authorized to use driver-facing cameras, but further restrict their usage to a reduced resolution. The vehicle then may, upon receiving these modified monitoring settings, operate the in-vehicle monitoring system according these new preferences. It is noted that for future use with this particular vehicle, this process may not be needed, as the modified user privacy profile now incorporates all relevant features to enable a future mapping of vehicle sensors and features to those specified by the modified monitoring settings.

The user privacy profile as discussed herein may be created by any suitable number of different users. Thus, the local application of monitoring settings by the DMS implemented in the vehicle 901 may take into consideration the monitoring settings of multiple users that may use the vehicle 901. In one scenario, multiple users, some or all of whom may have previously created a user privacy profile, may be occupants in the vehicle 901. In such a case, the vehicle 901 may receive a user profile of each of the vehicle occupants. The processing circuitry 902 may execute instructions stored in the user monitoring setting application module 911 to resolve the user's different monitoring settings, and then enable the vehicle DMS to operate by applying monitoring settings that implement monitoring settings that address those of the different occupants. That is, the monitoring settings apply to each individual, and thus the vehicle 901 may execute the in-vehicle monitoring system to collect sensor data using sensors, sensor settings, etc. in the vehicle by applying the monitoring settings associated with each of the vehicle occupants.

To do so, the vehicle 901 may transmit (via the use of the communication circuitry 904) a request to a UE or other suitable computing device identified with each vehicle occupant, which may be via direct communications, communications via the computing devices 910, etc. In any event, the transmitted request may prompt one or more of the vehicle occupants for permissions that may temporarily deviate from the user's preferred monitoring settings. If at least one user fails to grant this access, then the monitoring settings among the users may be resolved by the vehicle 901 by applying common settings among the different users, with a subsequent transmission notifying the users of this consequence (such as the unavailability of a safety-enhancing service).

In the above-referenced scenario, this might include a user A (the driver) and user's B and C (passengers) riding in the vehicle 901. The driver may have monitoring settings that indicate that driver-facing and in-cabin cameras may be used but restricts the use of other in-cabin monitoring cameras (See FIG. 11), passenger B may have monitoring settings that restrict the use of driver-facing cameras but do not restrict the use of in-cabin monitoring cameras, whereas user C may have monitoring settings that do not restrict the use of driver-facing cameras but restrict the use of in-cabin monitoring cameras. In this scenario, the vehicle 901 needs to determine the role of each user in the vehicle to apply each user's preferred monitoring settings. To determine this information, the DMS of the vehicle may request to temporarily enable all in-vehicle cameras to perform an identification and localization (such as via the use of user authentication algorithms used by the DMS of the vehicle 901) of each of the users A, B, and C within the vehicle 901, thus mapping their roles while riding in the vehicle 901.

Thus, the vehicle may transmit a request to one or more of the users A, B, and C to allow for a one-time use of a “person localization” monitor that requires enabling all in-vehicle cameras. If one of the users A, B, and C does not authorize this use of all in-vehicle cameras, then the vehicle 901 may resolve the differences among the monitoring settings by disabling the use of both driver and in-cabin cameras, alternatively use LIDAR sensors for both driver and occupancy monitoring (assuming this option is available), and transmit a notification to each user (such as via each user's UE) indicating that these alternate monitoring settings will be used. This is the result of the vehicle 901 not being able to adequately identify each user's role in the vehicle 901, and thus the conflicts among the user monitoring settings may not be resolved without disabling both the in-cabin and the driver-facing cameras.

However, assuming that each of the user A, B, and C do agree to the use of the in-vehicle camera settings, the vehicle 901 may determine that there actually is not conflict for the use of the driver-facing cameras, as the inly user with monitoring settings that restrict its use is the user B, who is identified as a passenger. Moreover, only the user's A and C having monitoring settings that restrict the use of in-cabin monitoring settings, but this only applies to the user C as the user A is the driver. Thus, the vehicle 901 may resolve these differences in monitoring settings in this scenario by activating the use of the in-cabin monitoring cameras, but applying a “mask” so that only the camera images associated with the space occupied by the user C is not saved or utilized. Alternatively, if there are several in-cabin sensors, a subset of these in-cabin sensors may be used that do not capture images of the user C. Of course, in any event the application of these monitoring settings and any consequences to the DMS features may be conveyed via the transmission of a suitable message to each of the vehicle occupants.

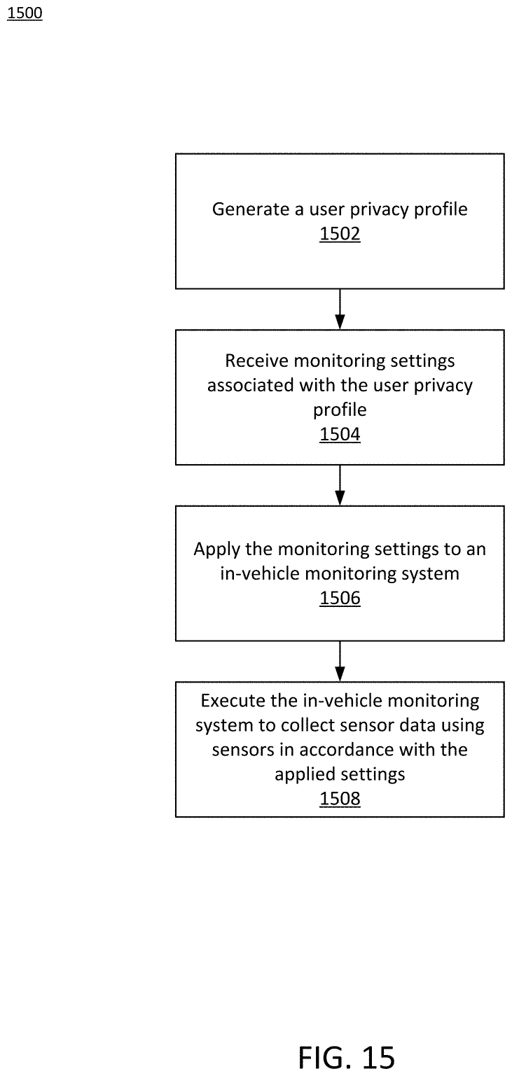

FIG. 15 illustrates a process flow, in accordance with the present disclosure. With reference to FIG. 15, the flow 1500 may be a computer-implemented method executed by and/or otherwise associated with one or more processors (processing circuitry) and/or storage devices. These processors and/or storage devices may be associated with one or more computing components identified with any suitable computing device (such as the computing devices 910 or the UE 912) and/or may include one or more processors identified with the vehicle 901 (such as the processing circuitry 902).

The one or more processors identified with one or more of the computing components as discussed herein may execute instructions stored on any suitable computer-readable storage medium that may or may not be shown in the Figures (and which may be locally-stored instructions and/or as part of the processing circuitries themselves, such as the user monitoring settings application module 911, executable instructions stored on the UE 912, executable instructions stored on the computing devices 910, etc.). The flow 1500 may include alternate or additional steps that are not shown in FIG. 15 for purposes of brevity, and may be performed in a different order than the steps shown in FIG. 15.

Flow 1500 may begin when one or more processors generate (block 1502) a user privacy profile. This user privacy profile may be associated with monitoring settings for in-vehicle monitoring systems that are to be applied by a vehicle depending on various use cases, vehicle types, user roles, etc., as discussed in this Section.

Flow 1500 may include one or more processors receiving (block 1504) monitoring settings, which may be associated with the user privacy profile. This may include receiving the monitoring settings from communications with a UE (such as US 912) or via communications with a remote computing device (such as the computing devices 910), in which a specific user privacy profile is received. This may additionally or alternatively include receiving the monitoring settings stored locally in the vehicle for a particular user, such as the user's private vehicle. The monitoring settings may specify various preferences regarding various use cases, types of sensors used for the collection of sensor data during in-vehicle monitoring, how the data may be collected, used, stored, shared, etc., as discussed throughout this Section. Again, the monitoring settings may correlate to a specific user, type of vehicle, the user's role in that vehicle, etc.

Flow 1500 may include one or more processors applying (block 1506) the monitoring settings to an in-vehicle monitoring system. As noted above, this may include interpreting the monitoring settings and adjusting the sensors that may be used, the sensor operation settings, etc., for execution of the in-vehicle monitoring system. This may include using sensors in the vehicle that are mapped to sensors identified by the settings associated with the user privacy profile. Thus, this mapping may consider the type of vehicle, the user, the user's role in the vehicle, etc., which may be specified in the monitoring settings.

Flow 1500 may include one or more processors executing (block 1508) the in-vehicle monitoring system to collect sensor data using sensors in accordance with the applied monitoring settings. This may include not only utilization of specific sensor types, but additionally or alternatively may include executing the in-vehicle monitoring system to utilize specific sensor settings (such as specific resolutions), utilizing a specific data source (such as anonymized data), deleting collected sensor data after a period of time indicated by the monitoring settings, etc. This may also include the transmission of data to a suitable computing device (such as the UE 912) during execution of the in-vehicle monitoring system as discussed herein to convey to a user which sensors are being used, how the sensor data is being collected and retained and/or shared, etc.

General Operation of a Vehicle

A vehicle is provided. With reference to FIG. 9, the vehicle includes a memory configured to store computer-readable instructions, and a processor configured to execute the computer-readable instructions to cause the computing device to: receive settings associated with a user privacy profile, the settings corresponding to a selection of sensors that are authorized to collect sensor data in accordance with an in-vehicle monitoring system during vehicle operation; and execute the in-vehicle monitoring system to collect sensor data using sensors in the vehicle that are based upon an application of the settings associated with the user privacy profile. The processor is configured to execute the computer-readable instructions to cause the vehicle to transmit data to a user equipment (UE) indicative of sensors in the vehicle that are being used to collect the sensor data while executing the in-vehicle monitoring system. In addition or in alternative to and in any combination with the optional features previously explained in this paragraph, the processor is configured to execute the computer-readable instructions to cause the vehicle to execute the in-vehicle monitoring system to collect sensor data using sensors in the vehicle that are mapped to sensors identified by the settings associated with the user privacy profile. In addition or in alternative to and in any combination with the optional features previously explained in this paragraph, the processor is configured to execute the computer-readable instructions to cause the vehicle to receive modified settings associated with a modified user privacy profile. In addition or in alternative to and in any combination with the optional features previously explained in this paragraph, the vehicle includes additional sensors that cannot be mapped to sensors identified by the settings associated with the user privacy profile, the modified settings correspond to a further selection of the additional sensors in the vehicle that are authorized to collect sensor data in accordance with the in-vehicle monitoring system during vehicle operation, and the processor is configured to execute the computer-readable instructions to cause the vehicle to execute the in-vehicle monitoring system to collect sensor data using sensors in the vehicle that are based upon an application of the modified settings associated with the modified user privacy profile. In addition or in alternative to and in any combination with the optional features previously explained in this paragraph, the user privacy profile is from among a plurality of user privacy profiles, each one of the plurality of user profiles being associated with a respective user's settings corresponding to a selection of sensors that are authorized to collect sensor data in accordance with the in-vehicle monitoring system during vehicle operation, and wherein the processor is configured to execute the computer-readable instructions to cause the vehicle to execute the in-vehicle monitoring system to collect sensor data using sensors in the vehicle that are based upon settings from among the plurality of user privacy profiles.

Section III—Methodology to Improve Monitoring Capabilities using a Photorealistic Synthetic User Dataset

As noted herein in the previous Sections, vehicles may use in-vehicle monitoring systems, such as a DMS, to monitor vehicle occupants for various purposes. As discussed above in Section I, machine learning trained models may be implemented for various in-vehicle monitoring functions, which may be trained using image, video, and/or audio data, among other types of data that form what is referred to as a training dataset. As noted herein, the data used for these training datasets may be obtained from various sources, which may include the in-vehicle monitoring systems that collect and use such data to re-train the machine learning trained models, to personalize such models per user, etc., which may improve the accuracy of the in-vehicle monitoring functions over time.

However, precisely monitoring driver and passenger activities using such machine learning approaches requires a tremendous amount of data. That is, the training datasets noted above are typically generated from large naturalistic data collections with multiple users. Moreover, and as noted above with respect to Section I, the resulting machine learning trained models may introduce issues during inference due to the lack of customized data when such training datasets are implemented. These dataset issues may make the in-vehicle DMS more vulnerable to making the wrong decision for a particular user, thereby causing false positives or false negatives. In machine learning, this issue is typically referred to as the “no free lunch theorem.” That is, given that data available is finite and is derived from multiple users, the distributions of the sample data and the test data cannot be the same. This results in trained systems, such as DMS, which face occasional biases when certain skin colors or biological traits are not present in the training dataset.

Current solutions to this issue includes the use of large datasets collected over an extended period of time, which are then curated for balancing distributions over a number of known performance indicators that define the required Operational Design Domain. However, such efforts are usually long and costly. Other solutions attempt to address this issue using a combination of captured sensor data and synthetic vision-based approaches, in which the original data is augmented using some artificially-generated data. Still further, other existing machine learning approaches rely on 3D models to simulate user interaction, but such techniques lack a photorealistic simulation of the user, both in the level of detail in physical appearance (pixel-to-pixel identical digital duo of the user), as well as the user's unique facial and gesture behaviors.

Each of these previously-described solutions are also costly to develop and curate, as the majority of the development time of machine learning solutions is spent on the data preparation and curation. Other issues introduced by existing solutions relate to the accuracy and reliability of the system. For instance, any changes to the user's facial features (hair changes, growing a mustache or beard, wearing new eye glasses, etc.) may degrade the precise monitoring capabilities. The use of color, depth camera, and skeleton data may be used, but such techniques have limitations with respect to the level of detail that may be obtained for a user from certain angles.

In this Section, techniques are disclosed to address these issues by generating highly specialized algorithms for DMS, which utilize a rendering methodology to create a hyper-realistic digital representation of the user, and which may then be used to generate a dataset for customization of the DMS algorithms to the individual user, thereby improving performance of the overall system. The approaches as discussed herein help provide an unlimited dataset using a 3D photorealistic model of the user with advanced rendering techniques, such that the model closely approximates sensor data acquired from real video captured of the user. The 3D photorealistic model may be modified over time to incorporate changes to hair style or skin tone, and may represent a pixel-to-pixel similarity between real and rendered content.

The techniques described in this Section develop customized algorithms for a DMS by use of a hyper-realistic digital human (identical to the user), which may be referred to throughout the Section as a “digital duo.” The digital duo may be created using digital textures to train DMS machine learning algorithms, thereby improving the overall task accuracy of driver monitoring. The techniques disclosed in further detail in this Section result in an improvement to the accuracy for the targeted user, and may function to learn and adapt to the changes of the user's physical appearance. Furthermore, the techniques disclosed in further detail in this Section may enable the automatic generation of a dataset that is used to retrain a DMS in various conditions, and may use an existing skeletal motion dataset to perform re-training of the machine learning trained model used for the DMS.

Recent advancements in rendering technologies, such as Metahuman and Nanite from the

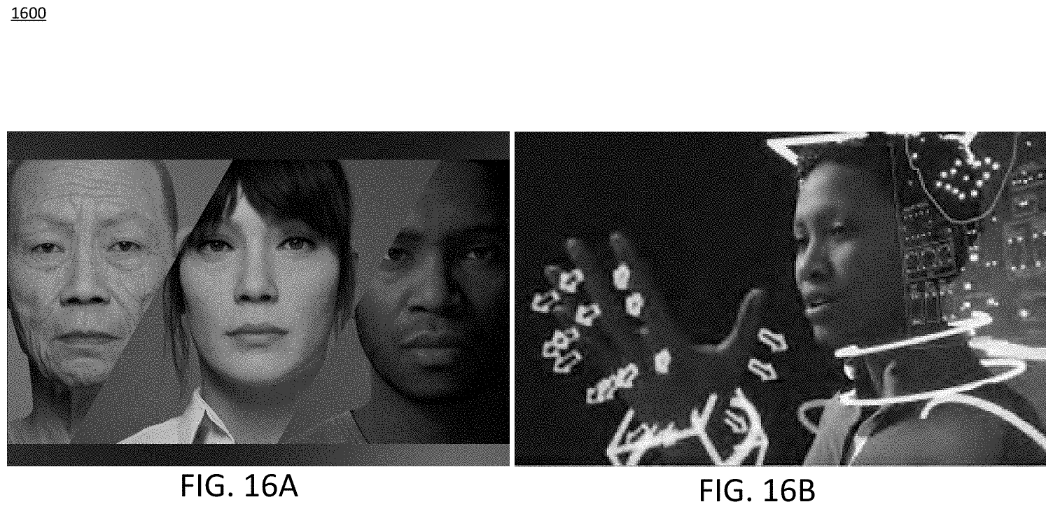

Unreal game engine, have pushed the limits of photorealism in artificially-rendered realistic human characters for use in interactive applications such as gaming, digital assistants, etc. The use of the Metahuman technology is shown in FIGS. 16A-16B, with FIG. 16A illustrating a rendering of realistic human characters to model different racial features, and FIG. 16B illustrating a rendering of realistic human characters to highlight skeleton joints to control a three-dimensional (3D) avatar. The images shown in FIGS. 16A-16B demonstrate the level of realism that can be achieved as of this writing using the Unreal game engine at >60 fps. FIG. 16B further illustrates how generated metahumans can be controlled at various waypoints.

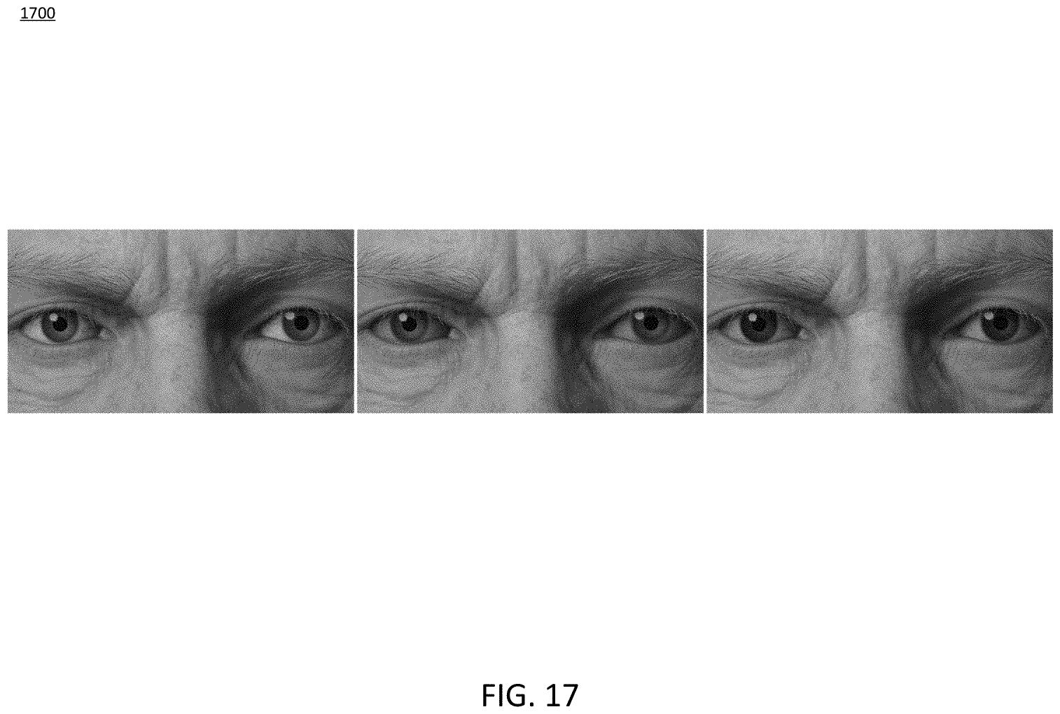

The level of detail and the resolution at which such metahumans are rendered may be leveraged in accordance with the techniques discussed throughout this Section. That is, user-specific 3D models, or digital duos, of users may be generated using these or other suitable techniques, including known realistic metahuman generation techniques, as the basis of a training dataset for critical uses such as DMS. It is further noted that such techniques may include a high level of detail, which may encompass the iris color and shape of the person, as shown in FIG. 17.

Thus, the techniques described in this Section provide a methodology to use such capabilities in a DMS by creating a digital duo, which is a digital representation or 3D model rendering of the user, and progressively use this digital duo to train the DMS functions. The specific details regarding the various components of the vehicle, UEs, and other computing devices that are remote to the vehicle, which may be used for training machine learning models, is not repeated in the Figures referenced in this Section for purposes of brevity. However, it will be understood that such components may be identified and/or operate in a similar manner as those discussed herein in Section II with reference to the vehicle 901, UE 912, and computing devices 910. Thus, reference may be made to FIG. 9 in this context, as these components as described herein may communicate with one another and perform similar functions as those noted in Section II.

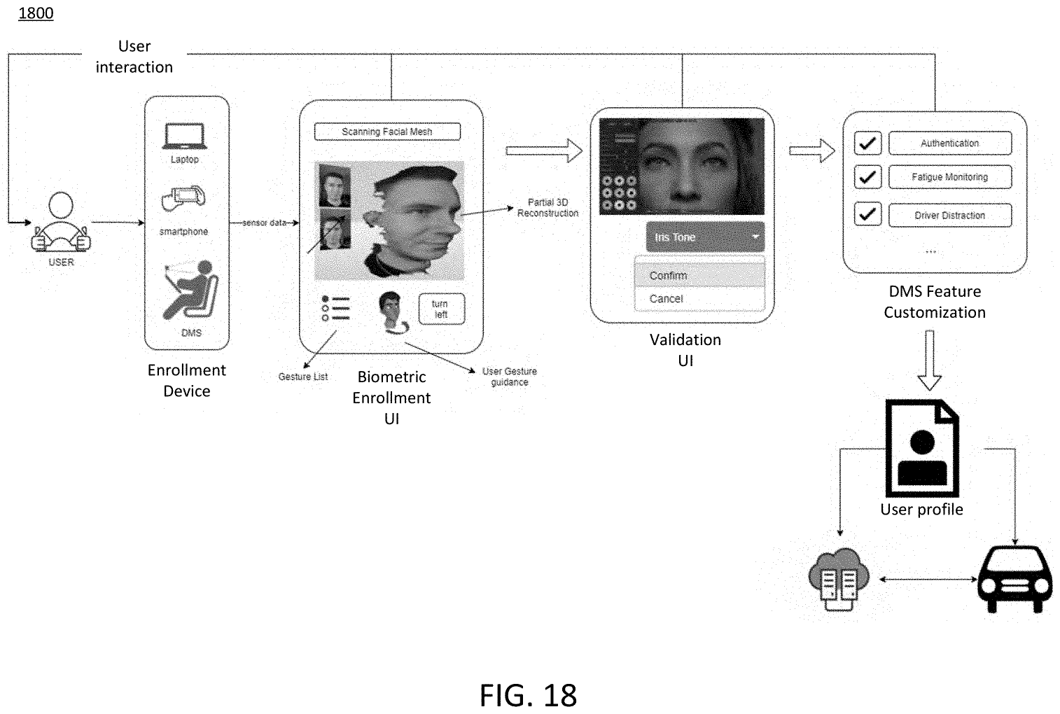

FIG. 18 illustrates a process flow for generating a user-specific dataset for machine learning model training, in accordance with the disclosure. The process flow 1800 as shown in FIG. 18 may be referred to as an enrollment process, and is used to facilitate the generation of a 3D mesh of a portion of the occupant of the vehicle. As further discussed in this Section, the 3D mesh may be overlaid onto a reference 3D model to generate a 3D model that is specific to the occupant of the vehicle for which the DMS will be used to perform DMS-based functions. Thus, the enrollment process as shown in FIG. 18 may enable a user to create a user profile (i.e. a digital profile) that may include a single 3D mesh that is identified with that digital profile. The digital profile may include, in addition to the 3D mesh, any other suitable parameters associated with the 3D mesh such as textures, color, etc. As discussed in further detail in this Section, the single 3D mesh created per user may then be used for training multiple DMS functions.

The enrollment process may be completed using any suitable number and/or type of computing device, such as a user equipment (UE) that may include a mobile phone, a laptop, or the DMS in the vehicle, and which may operate in a similar manner as the vehicle 901 or the UE 912 as discussed in Section II with reference to FIG. 9. Thus, the enrollment device may execute a suitable application as shown in FIG. 18 to guide a user to perform a series of movements, postures, facial expressions, etc., and to collect sensor data (such as images, video, audio, etc.) from one or more sensors of the UE as part of this process. This may include the use of cameras, LIDAR, gyroscope data, accelerometer data, etc., to obtain a 3D mesh of the user using any suitable techniques to do so, including known techniques. The UE may further facilitate the user performing a registration process to create a user profile that enables subsequent identification of the user (such as via a login process) and access to the data associated with the user profile.

As noted further herein, a DMS may perform various DMS-based functions based upon the particular application and feature set. Each DMS-based function may operate in accordance with a machine learning trained model that has been trained using a dataset to enable the DMS to perform that specific DMS-based function, such as occupant monitoring. That is, and as shown in FIG. 18, various DMS-based functions may include a driver authentication feature, a fatigue-monitoring feature (as noted in Section I), and a driver distraction feature. Of course, the actual DMS-based features may be greater than, fewer than, or include DMS-based functions other than those shown in FIG. 18.

Each of these DMS-based functions may be trained using a different set of training data. The UI of the enrollment device may thus function to walk the user through various steps to ensure an adequate amount of data is collected for each DMS-based function to generate a 3D mesh of at least a portion of the user's body (such as the face). As noted herein, the 3D mesh may then be used to generate the user-specific training dataset to enable the DMS to perform each DMS-based function using that specific machine learning trained model.

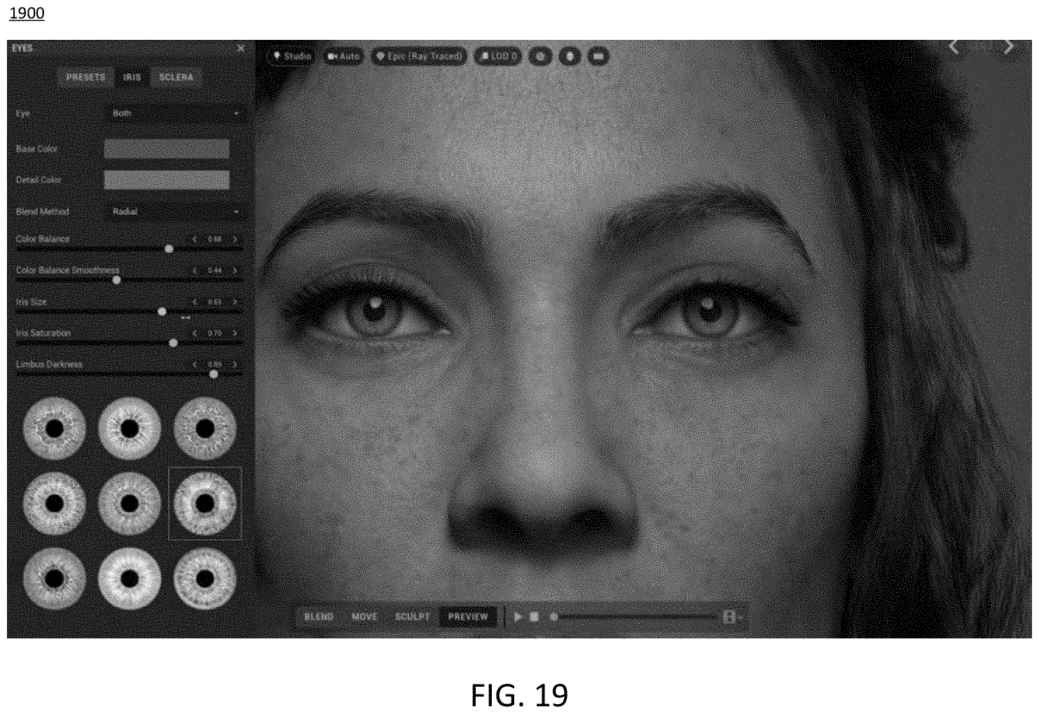

It is noted that the enrollment process is directed at recording and capturing not only the external surface (i.e. skin/eye color, hair, etc.), but also the musculoskeletal constitution and range of motion of the user. The UI guidance may thus also include performing certain actions in the vehicle (if the enrollment is done in-cabin). Once an adequate amount of data is collected to generate the 3D mesh in this manner, the enrollment device (or other suitable device) may present, via the UI to the user, a prompt to validate/modify the generated 3D mesh. A non-limiting UI for this purpose is shown in further detail in FIG. 19, which enables a user to alter/fine tune the 3D mesh and to also validate whether the representation is accurate. It is noted that modifications may be limited to only certain parameters, to only the adjustment within certain parameter ranges, etc., to avoid the user placing idealistic (i.e. non-realistic) avatar representations.

In addition, during the enrollment process the user can select which DMS service/feature for which the data is being collected (such as the authentication feature, the fatigue monitoring feature, etc.). Thus, once the enrollment process is complete, a user profile is created that contains a 3D mesh of the user. The 3D mesh may represent a complete 3D representation of the user, although different DMS-based functions might use only a subset of that mesh during the training process. That is, a machine learning trained model used for gaze detection might only use the head and eye positions to estimate direction or gaze. As an alternate scenario, a machine learning trained model used for user authentication might use not only the head, but also other body ratios to perform the authentication process. The user profile as shown in FIG. 18 may then be stored in any suitable location, such as in a remote cloud-based storage (such as the computing devices 910), in the UE (such as the UE 912), in the vehicle (such as the vehicle 901), etc. In one scenario, once the user registration and 3D mesh creation process is validated as discussed above, the created user profile is then uploaded to the cloud for training the specified machine learning models for each of the DMS-based functions using the 3D mesh data, as shown in FIG. 18.

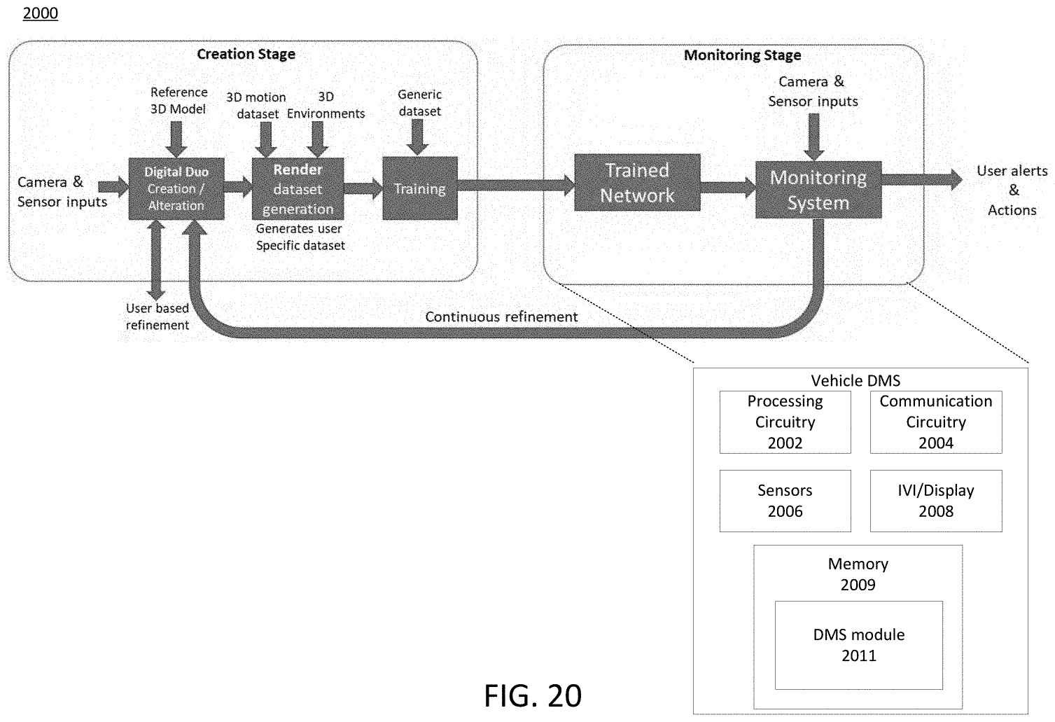

The enrollment process thus functions to generate the 3D mesh data for the user, and may form part of a larger overall creation stage that generates a user-specific training dataset to enable each DMS-based feature. This overall process is shown in further detail in FIG. 20, which represents a process flow for the implementation of DMS-based functions using a creation stage and a monitoring stage, in accordance with the disclosure. The creation stage includes the aforementioned enrollment process to generate the 3D mesh data for a particular user that is then used to train the machine learning models for each DMS-based function. The training process includes the selection of the portions needed to generate the training data based upon the specific DMS function that is being trained. This may be performed offline using any suitable type of simulation engine and a guided dataset to synthetically generate the realistic input for the training of the personalized 3D model. The creation stage thus further includes generating, from the 3D mesh, an identical digital duo of a corresponding portion of the user (such as the user's head, torso, etc.) used to train the machine learning model for each respective DMS-based function.

As discussed in further detail in this Section, for each DMS-based function, a different reference 3D model may be combined with corresponding portions of the generated 3D mesh to generate an initial user-specific 3D model. This may be implemented by overlaying the portions of the 3D mesh in each case (i.e. for each DMS-based feature) onto the reference 3D model. The reference 3D model may correspond to a generic reference model (i.e. not specific to the user), that is nonetheless specific to the particular motions, behaviors, etc., that are identified with a specific DMS-based feature associated with the 3D mesh. The reference 3D model may thus be obtained from any suitable source or database, which may include the use of generic training data for this purpose. As one scenario, a base 3D model may be obtained from a preexisting database, and configurations on such a base 3D model may be performed to account for individual differences. This may include selecting a middle aged/middle build 3D model (3D skeleton) but modifying the 3D model because the user is missing one finger on the right hand.

The initial user-specific 3D model may thus represent a 3D model for a particular user, which is the result of overlaying the portions of the 3D mesh onto the reference 3D model. The initial user-specific 3D model may be further refined to generate a final user-specific 3D model using cues from the user video feed used to create the 3D mesh (i.e. from the UE, in the vehicle, etc.). These cues may include the system requests (such as via a UI of the UE used as part of the enrollment process as noted herein) for the user to perform a particular action or to pose in a particular way. Doing so enables the reference data for that action/cue better capture the musculoskeletal structure of the user's body as well as other behavioral mannerisms that are critical for the model training. This overlaying process may therefore include mapping points in the 3D mesh that are identified via the collected sensor data to matching points in the reference 3D model (such as eyes, nose, mouth, hair, etc.) to further alter the 3D and texture parameters of the 3D mesh to create a refined user-specific 3D model, which is referred to herein as a digital duo/twin of the user. This digital duo thus represents a pixel-to-pixel identical digital duo of the user.

The creation stage further includes using the digital duo of the user, which again represents a 3D model or rendering of the user including user-specific physical attributes, to generate a user-specific training dataset, as shown in FIG. 20. The user-specific dataset may be generated in this manner for each specific type of DMS-based function by using the digital duo, for each DMS-based function that is to be trained, in conjunction with a 3D motion dataset and 3D environment data. The application of the 3D motion dataset and the 3D environment to generate the user-specific training data is further discussed below with respect to the training process.

The creation stage may be implemented by any suitable number and/or type of computing devices, with any suitable portion of the creation stage being implemented by one or more of these computing devices independently or in combination with one another. In some scenarios, the camera or other sensor input data may be identified with a UE (such as the UE 912 as discussed herein in Section II), the in-vehicle sensors and cameras (such as those implemented by the vehicle 901), etc. Thus, the UE and/or the vehicle may be implemented to generate the 3D mesh of the user, or the sensor data collected from the UE or the vehicle may be transmitted to a remote computing device that generates the 3D mesh or the user. The remote computing device may include a cloud computing device or other suitable computing device that is remote to the UE and the vehicle (such as the computing devices 910).

Furthermore, the same computing device(s) that collects the sensor data with respect to the user for the purpose of generating the 3D mesh may be used to generate the digital duo of the user via the aforementioned overlaying process, to render the user-specific data set using the 3D motion dataset and the 3D environment data, and may additionally be used to perform the machine learning training process. In one scenario, once a 3D mesh is generated for the user, the 3D mesh may be transmitted to the remote computing device(s) (such as the computing devices 910), and this remote computing device may perform the rendering of the user-specific dataset and the training of the machine learning model.

In any event, the creation stage further includes a machine learning model training process that is implemented using a user-specific dataset that is generated from the digital duo of the user, and which results in a machine learning trained model that may be used for each DMS-based function that is to be implemented by the vehicle DMS as discussed throughout this Section. The user-specific dataset generation and training process may be separate phases, or be an integrated phase, as is the case in reinforcement learning techniques. The user-specific dataset generation and training processes may be implemented by the same computing device or as separate processes on separate computing devices, in various scenarios.

The user-specific dataset may be generated in any suitable manner using the user-specific 3D model as discussed above, i.e. the digital duo. This may include feeding the customized, i.e. user-specific 3D model or digital duo, into any suitable type of simulator, such as a virtual driving simulator, which may generate the 3D motion dataset and 3D environment data. In this case, the simulator may contain variable in-vehicle scenes such as in-cabin models representing multiple vehicle models. Additionally, the simulator may provide varying external conditions, including light and traffic conditions, which create the necessary input needed for the training of the DMS function as part of a particular driving task. Thus, the simulator generates the 3D motion dataset and 3D environment data for various scenarios, and then generates the necessary user-specific dataset for training the machine learning model for each particular DMS-based function (i.e. emotion detection, drowsiness detection, gaze tracking, distraction recognition, behavior recognition, etc.). This process may include performing environmental variations as identified by the 3D environment data as shown in FIG. 20, and may include lighting conditions supported by any suitable type of driving simulators, including known driving simulator types such as CARLA. The user-specific dataset may be combined with a generic dataset to ensure an adequate sampling of data over various conditions and scenarios. As one scenario, synthetically generated data may be implemented for the personalization in combination with other generic data, which allows the machine learning model to be trained for a particular DMS function and thus perform better compared to the use of only the generic training dataset.

Thus, the 3D motion dataset may correspond to a pre-existing 3D motion synthetic dataset composed of 3D models in various DMS scenarios, i.e. for different DMS-based functions. Each reference 3D model may be integrated with the digital duo “skin,” which modifies the basic 3D rig structure of the reference 3D model with the customized musculoskeletal and detailed surface profile for that specific user identified with the digital duo. This process results in a modification to the physical behavior and rendering of the reference 3D model to generate a corresponding user-specific 3D model. In other words, the result is a modification that is most apparent during the rendering of the synthetic data in the simulator to generate the personalized dataset for training the personalized model. The simulation engine makes use of the 3D motion datasets, which include descriptions of the movements that a 3D model performs in given scenarios (which include environmental descriptions as well as traffic), and the digital duo profile that is integrated with the 3D model is then rendered. Then, synthetic sensors may capture that rendered input to generate the dataset needed for machine learning training purposes. Of course, the use of the synthetic sensors may depend upon whether the DMS algorithms use offline or online training, and thus the generated dataset for training may include either the dataset files or, alternatively, the 3D model may be coupled with the simulator such as in the case of reinforcement learning.

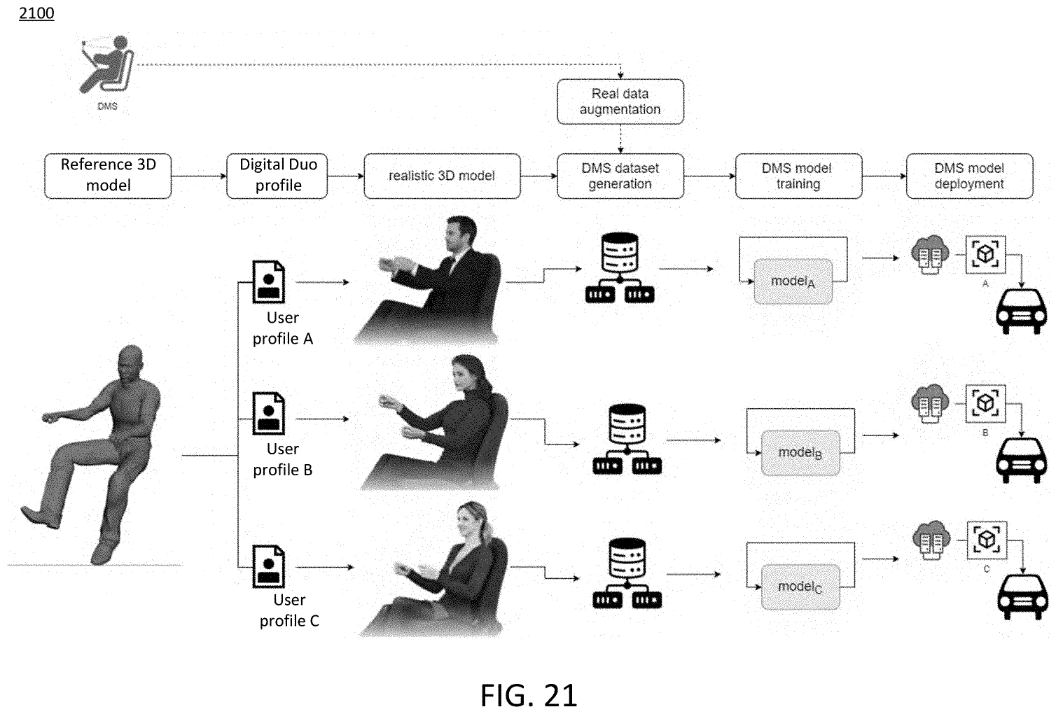

As a result of this process, the user-specific training dataset is generated corresponding to various movements of the digital duo (i.e. the 3D model that is specific to the user), in various environments (such as different lighting conditions within the vehicle associated with the operation of the DMS) versus a conventional training dataset that may represent movement of different people but does not use 3D models of those people. Thus, the user-specific dataset may represent training data that is derived from the digital duo of the user for each particular DMS-based function that is to be trained, as further discussed throughout this Section. This process is discussed in further detail below with respect to FIG. 21. As a result of the creation stage, a machine learning model is trained using a user-specific training dataset that is based upon (such as via simulations using) a three-dimensional (3D) model that is specific to the occupant of the vehicle.

The monitoring stage may be identified with any suitable type of computing device, such as a vehicle that implements the DMS-based functions as discussed throughout is Section. The vehicle may be identified with the vehicle 901, which may include the related DMS components as discussed above with reference to Section II. Thus, the processing circuitry 2002, the communication circuitry 2004, the sensors 2006, the IVI/display 2008, and the memory 2009 may be identified with or operate in an identical or substantially similar manner as the processing circuitry 902, the communication circuitry 904, the sensors 906, the IVI/display 908, and the memory 909, respectively, as discussed above in Section II. Thus, a further description of the operation and functionality of these components is not provided for purposes of brevity.

The memory 2009 may include a DMS module 2011, which may store computer-readable instructions executable by the processing circuitry 2002 to implement the various DMS-based functions as discussed in this Section. This may include the use of the trained network as shown in the monitoring stage in FIG. 20, which may be implemented in accordance with any suitable type of machine learning trained network (such as a neural network) to which the machine learning trained model is deployed for use by the vehicle DMS.

Once the training process has been completed, the machine learning trained model is then deployed to the DMS, which uses the trained network and the sensor inputs to monitor the user behavior and to perform the DMS-based functions. That is, via execution of the DMS module 2011 via the processing circuitry 902, the vehicle may receive the machine learning trained model that has been trained using the user-specific training dataset that identifies various DMS functions for the user, who may be an occupant of the vehicle. The DMS thus operates in this manner to receive sensor data (images, LIDAR data, audio, etc.) associated with the occupant of the vehicle for which the DMS-based functions were trained using the user-specific training dataset, and during execution of the DMS the sensor data is received and analyzed in accordance with the machine learning trained model to perform one or more DMS-based functions.

The sensor data obtained via the sensors 2006 in the vehicle DMS may also be used during the monitoring stage to collect sensor data with respect to the user. This sensor data (or any other suitable data collected via the DMS) may then be transmitted to a suitable computing device (such as the cloud, computing devices 910, the vehicle, etc.) and used to re-train the machine learning trained models over time as part of the creation stage as shown in FIG. 20. This may include modifying the 3D model that is specific to the occupant of the vehicle using the sensor data that is collected during DMS operation to generate a modified 3D model (i.e. a modified digital duo) of the user. In one scenario, this may include refreshing or otherwise updating the 3D mesh data and/or the 3D model generated from an overlay of the 3D mesh onto the reference 3D model data, as noted above. The dataset generation and training processes as discussed above may then be repeated by generating a new, modified user-specific training dataset that incorporates the changes to the modified digital duo, and training the machine learning models using the updated user-specific training dataset (as well as the generic dataset as noted above). In this way, the customized (i.e. user-specific) 3D models may be continuously improved over time, which may be particularly advantageous to account for physical changes of the user, thereby maintaining the accuracy of the DMS-based functions.

Alternatively, the collected sensor data may be anonymized by integrating the sensor data that indicates various behaviors with a “master digital duo,” which may then enable data sharing for distributed learning/optimization methods. That is, at times it may be difficult to collect certain types of data because the specific type of data dos not occur with a high frequency of use. That is, specific scenarios may lack an availability of data for training purposes. As one illustrative scenario, a machine learning model may be trained for a DMS function related to prediction of driver attention, but there is a lack of data points for drivers performing a lane change at night while being blinded by oncoming traffic lights. In such instances, a sequence of events may be collected that are significantly rare in their occurrence, and it may be desirable to incorporate these into other 3D models for incorporation into machine learning models for DMS functions for other users. However, in such a case the privacy of the user should still be respected. Thus, the data associated with such “rare” occurrences may be anonymized, which may be implemented by integrating the sensor data with a “master digital duo,” which does not look like the user identified with the data source. The anonymized data generated using the master digital duo in this way may advantageously be shared to improve not only the source user's DMS algorithms, but also other users′ algorithms without sacrificing user privacy.

FIG. 21 illustrates a process flow for the implementation of DMS-based functions for multiple users, in accordance with the disclosure. As noted above for FIG. 20, each step in the process flow 2100 may be performed by any combination of computing devices such as the UE 912, the vehicle 901, the computing devices 910, etc. As shown in FIG. 21, reference 3D model dataset is shown, which corresponds to a reference 3D model identified with a particular DMS-based function. This DMS-based function may correspond to any suitable type of DMS operation for which a machine learning trained model is to be generated using each user's specific digital duo, such as emotion detection, drowsiness detection, gaze tracking, distraction recognition, behavior recognition, etc. Thus, the reference 3D model may correspond to an archetype 3D model that pertains to the portions of the user for which DMS machine learning model is to be trained.

As shown in FIG. 21, each user is assumed to have a digital duo created as part of the enrollment process described herein. Three separate users A, B, and C are shown in FIG. 21 for purposes of brevity and not by limitation, as the process flow 2100 may be applied for any suitable number of users, each having their own digital duo that is accessed via an individual user profile as shown. As noted in this Section with respect to FIG. 20, the 3D mesh identified with each user's profile is applied or overlaid onto the reference 3D model dataset to generate, for each different user, a user-specific 3D model for that user (i.e. the digital duo referred to as the “realistic 3D model” in FIG. 21).

Next, the user-specific 3D model is used to generate a DMS dataset for training the machine learning model for a specific DMS-based function. Again, this may be the result of using the user-specific 3D model (i.e. the digital duo) as part of a simulation that incorporates synthetic 3D motion and 3D environment data to generate a user-specific dataset, as discussed above with reference to FIG. 20. The DMS dataset generation process may thus be identified with the dataset rendering process as discussed herein with reference to FIG. 20, and therefore the DMS dataset may include the incorporation of the generic dataset as noted herein.

Additionally, the DMS dataset may be augmented with sensor data that is collected via the vehicle DMS, as shown in FIG. 21. The “real” data augmentation process may utilize raw data captured from the DMS (i.e. via the sensors 2006) while the user is an occupant in the vehicle. This may include the use of sensor data that was collected during a previous use of the DMS to perform the same DMS-based function for which the DMS dataset is to be used to perform the training process. The data augmented from the DMS may thus include sensor data that identifies the motion, lighting, etc. of the user for a specific DMS-based function. This process may additionally or alternatively be implemented for continuous learning by modifying the user-specific 3D model, as noted above with reference to FIG. 20.

Therefore, the DMS dataset may be generated in a manner that is specific to each individual user and DMS-based function. The DMS dataset may be used as the training data to perform machine learning model training using training data that is specific to that user based upon each user's user-specific 3D model. The DMS model training thus functions to utilize the DMS dataset generated for each user to train, for each DMS-based function, a machine learning trained model. This training process may be performed in accordance with any suitable techniques that utilize training data to perform machine learning model training for DMS-based functions, which may include the use of a neural network as discussed herein. In any event, once the machine learning trained model has achieved the desired performance, the customized (i.e. user-specific) machine learning trained model is then deployed back to the vehicle, where the DMS of the vehicle may utilize the machine-learning trained model to perform the corresponding DMS-based function during run-time.

Of course, the process flow 2100 as shown in FIG. 21 may be repeated to train machine learning models for any suitable number and type of DMS-based functions. That is, the reference 3D model as shown in FIG. 21 may represent a corresponding reference 3D model for any suitable DMS-based function that a machine learning model is to be trained. Thus, this process may be repeated for any suitable number of users to generate any suitable number of machine learning trained models, with each machine learning trained model being trained using a user-specific training dataset that is associated with a respective DMS function to enable the DMS to perform.

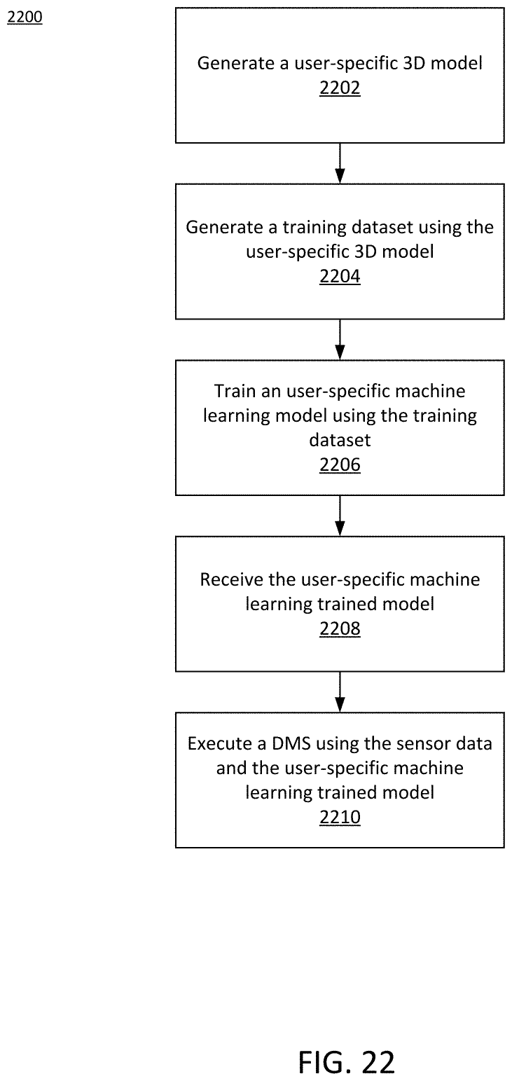

FIG. 22 illustrates a process flow, in accordance with the present disclosure. With reference to FIG. 22, the flow 2200 may be a computer-implemented method executed by and/or otherwise associated with one or more processors (processing circuitry) and/or storage devices. These processors and/or storage devices may be associated with one or more computing components identified with any suitable computing device (such as the computing devices 910 or the UE 912) and/or may include one or more processors identified with a vehicle (such as the processing circuitry 2002).

The one or more processors identified with one or more of the computing components as discussed herein may execute instructions stored on any suitable computer-readable storage medium that may or may not be shown in the Figures (and which may be locally-stored instructions and/or as part of the processing circuitries themselves, such as the DMS module 2011, executable instructions stored on the UE 912, executable instructions stored on the computing devices 910, etc.). The flow 2200 may include alternate or additional steps that are not shown in FIG. 22 for purposes of brevity, and may be performed in a different order than the steps shown in FIG. 22.

Flow 2200 may begin when one or more processors generate (block 2202) a user-specific 3D model. This user-specific 3D model may include the creation of the digital duo, which is generated by overlaying a user-specific 3D mesh onto a reference 3D model, as discussed in this Section.

Flow 2200 may include one or more processors generating (block 2204) a training dataset using the user-specific 3D model. This may include the use of simulations and/or synthetic 3D motion data, environment data, etc. to generate a user-specific dataset as noted in this Section. The training dataset may also include other types of data, such as a general dataset as discussed in this Section with reference to FIG. 20, the raw sensor data acquired by the DMS, etc.

Flow 2200 may include one or more processors training (block 2206) the machine learning model using the user-specific dataset. As noted above, this may include using the training dataset to perform machine learning model training in accordance with any suitable techniques, such as a neural network. The resulting trained machine learning model is therefore a user- or occupant specific machine learning trained model.

Flow 2200 may include one or more processors receiving (block 2208) the user-specific machine learning trained model. This may include deploying the user-specific machine learning trained model to the vehicle, as discussed in this Section.

Flow 2200 may include one or more processors executing (block 2210) a DMS using the user-specific machine learning trained model. This may include the DMS of the vehicle operating to receive sensor data associated with the occupant of the vehicle identified with the user, which may include images, video, audio data, etc., of the user. The execution of the DMS may also include using the sensor data in accordance with the user-specific machine learning trained model to perform one or more specific DMS-based functions, with each DMS-based function being performed using the corresponding machine learning trained model for that function, as discus sed herein.

General Operation of a Vehicle

A vehicle is provided. With reference to FIG. 9 and the vehicle DMS of FIG. 20, the vehicle includes a memory configured to store computer-readable instructions, and a processor configured to execute the computer-readable instructions to cause the vehicle to: receive a machine learning trained model that is trained using a training dataset that identifies a driver monitoring system (DMS) function; receive sensor data associated with an occupant of the vehicle; and execute a DMS to perform a DMS-based function using the machine learning trained model based upon the sensor data, wherein the training dataset is based upon a three-dimensional (3D) model that is specific to the occupant of the vehicle. The 3D model that is specific to the occupant of the vehicle comprises a 3D rendering of a portion of the occupant of the vehicle. In addition or in alternative to and in any combination with the optional features previously explained in this paragraph, the 3D model is generated based upon a portion of a 3D mesh of the occupant of the vehicle, which is overlaid onto a reference 3D model that is associated with a DMS-based function for which the machine learning trained model is trained to enable the DMS to perform. In addition or in alternative to and in any combination with the optional features previously explained in this paragraph, a sensor is configured to generate further sensor data identified with the occupant of the vehicle during execution of the DMS, wherein the 3D model that is specific to the occupant of the vehicle is modified using the further sensor data to generate a modified 3D model. In addition or in alternative to and in any combination with the optional features previously explained in this paragraph, the processor is configured to execute the computer-readable instructions to execute the DMS to perform the DMS-based function using the machine learning trained model that has been re-trained using a further training dataset that is based upon the modified 3D model. In addition or in alternative to and in any combination with the optional features previously explained in this paragraph, the machine learning trained model is from among a plurality of machine learning trained models, with each one of the plurality of machine learning trained models being trained using a user-specific training dataset that is associated with a respective DMS-based function for which each respective machine learning trained model is trained to enable the DMS to perform.

### EXAMPLES

The following examples pertain to various techniques of the present disclosure.

An example (e.g. example 1) relates to a vehicle. The vehicle includes a memory configured to store computer-readable instructions, and a processor configured to execute the computer-readable instructions to cause the computing device to: receive settings associated with a user privacy profile, the settings corresponding to a selection of sensors that are authorized to collect sensor data in accordance with an in-vehicle monitoring system during vehicle operation; and execute the in-vehicle monitoring system to collect sensor data using sensors in the vehicle that are based upon an application of the settings associated with the user privacy profile.

Another example (e.g. example 2) relates to a previously-described example (e.g. example 1), wherein the processor is configured to execute the computer-readable instructions to cause the vehicle to transmit data to a user equipment (UE) indicative of sensors in the vehicle that are being used to collect the sensor data while executing the in-vehicle monitoring system.

Another example (e.g. example 3) relates to a previously-described example (e.g. one or more of examples 1-2), wherein the processor is configured to execute the computer-readable instructions to cause the vehicle to execute the in-vehicle monitoring system to collect sensor data using sensors in the vehicle that are mapped to sensors identified by the settings associated with the user privacy profile.

Another example (e.g. example 4) relates to a previously-described example (e.g. one or more of examples 1-3), wherein the processor is configured to execute the computer-readable instructions to cause the vehicle to receive modified settings associated with a modified user privacy profile.

Another example (e.g. example 5) relates to a previously-described example (e.g. one or more of examples 1-4), wherein the vehicle includes additional sensors that cannot be mapped to sensors identified by the settings associated with the user privacy profile, the modified settings correspond to a further selection of the additional sensors in the vehicle that are authorized to collect sensor data in accordance with the in-vehicle monitoring system during vehicle operation, and the processor is configured to execute the computer-readable instructions to cause the vehicle to execute the in-vehicle monitoring system to collect sensor data using sensors in the vehicle that are based upon an application of the modified settings associated with the modified user privacy profile.

Another example (e.g. example 6) relates to a previously-described example (e.g. one or more of examples 1-5), wherein the user privacy profile is from among a plurality of user privacy profiles, each one of the plurality of user profiles being associated with a respective user's settings corresponding to a selection of sensors that are authorized to collect sensor data in accordance with the in-vehicle monitoring system during vehicle operation, and wherein the processor is configured to execute the computer-readable instructions to cause the vehicle to execute the in-vehicle monitoring system to collect sensor data using sensors in the vehicle that are based upon settings from among the plurality of user privacy profiles.

An example (e.g. example 7) relates to a vehicle. The vehicle includes a memory configured to store computer-readable instructions, and a processor configured to execute the computer-readable instructions to cause the vehicle to: receive a machine learning trained model that is trained using a training dataset that identifies a driver monitoring system (DMS) function; receive sensor data associated with an occupant of the vehicle; and execute a DMS to perform a DMS-based function using the machine learning trained model based upon the sensor data, wherein the training dataset is based upon a three-dimensional (3D) model that is specific to the occupant of the vehicle.

Another example (e.g. example 8) relates to a previously-described example (e.g. example 7), wherein the 3D model that is specific to the occupant of the vehicle comprises a 3D rendering of a portion of the occupant of the vehicle.

Another example (e.g. example 9) relates to a previously-described example (e.g. one or more of examples 7-8), wherein the 3D model is generated based upon a portion of a 3D mesh of the occupant of the vehicle, which is overlaid onto a reference 3D model that is associated with a DMS-based function for which the machine learning trained model is trained to enable the DMS to perform.

Another example (e.g. example 10) relates to a previously-described example (e.g. one or more of examples 7-9), a sensor configured to generate further sensor data identified with the occupant of the vehicle during execution of the DMS, wherein the 3D model that is specific to the occupant of the vehicle is modified using the further sensor data to generate a modified 3D model.

Another example (e.g. example 11) relates to a previously-described example (e.g. one or more of examples 7-10), wherein the processor is configured to execute the computer-readable instructions to execute the DMS to perform the DMS-based function using the machine learning trained model that has been re-trained using a further training dataset that is based upon the modified 3D model.

Another example (e.g. example 12) relates to a previously-described example (e.g. one or more of examples 7-11), wherein the machine learning trained model is from among a plurality of machine learning trained models, with each one of the plurality of machine learning trained models being trained using a user-specific training dataset that is associated with a respective DMS-based function for which each respective machine learning trained model is trained to enable the DMS to perform.

An example (e.g. example 13) relates to a computing device. The computing device includes a memory configured to store computer-readable instructions, and a processor configured to execute the computer-readable instructions to cause the computing device to: generate an enclave that is executed in a secure location of the memory and is protected by the processor; store user data received via an encrypted communication channel established between the enclave and a user equipment (UE) in the secure location of the memory as part of a training dataset; generate a machine learning trained model using the training dataset; and transmit the machine learning trained model to a vehicle that utilizes the machine learning trained model as part of a driver monitoring system (DMS).

Another example (e.g. example 14) relates to a previously-described example (e.g. example 13), wherein the user data comprises images of a user identified with a driver of the vehicle that utilizes the DMS.

Another example (e.g. example 15) relates to a previously-described example (e.g. one or more of examples 13-14), wherein the processor is configured to execute the computer-readable instructions to generate the machine learning trained model by re-training a previously-trained machine learning trained model using the training dataset.

Another example (e.g. example 16) relates to a previously-described example (e.g. one or more of examples 13-15), wherein the processor is configured to execute the computer-readable instructions to encrypt the machine learning trained model with a key that is stored in the secure location of the memory to generate an encrypted machine learning trained model.

Another example (e.g. example 17) relates to a previously-described example (e.g. one or more of examples 13-16), wherein the encrypted machine learning trained model is stored in a portion of the memory other than the secure location.

Another example (e.g. example 18) relates to a previously-described example (e.g. one or more of examples 13-17), wherein the processor is configured to execute the computer-readable instructions to cause the computing device to establish the encrypted communication channel via an attestation procedure performed with the UE.

Another example (e.g. example 19) relates to a previously-described example (e.g. one or more of examples 13-18), wherein the processor is configured to execute the computer-readable instructions to cause the computing device to establish a further encrypted communication channel between the computing device and the vehicle using an attestation request that is initiated by the computing device, and to transmit the encrypted machine learning trained model to the vehicle via the further encrypted communication channel.

An example (e.g. example 20) relates to a vehicle. The vehicle includes a memory configured to store computer-readable instructions; and a processor configured to execute the computer-readable instructions to cause the vehicle to: generate a vehicle enclave that is executed in a secure location of the memory protected by the processor; establish an encrypted communication channel between the vehicle enclave and a cloud enclave associated with a computing device; store an encrypted machine learning trained model received from the cloud enclave via the encrypted communication channel in the memory, the encrypted machine learning trained model being generated via the computing device using a training data set that includes user data identified with the vehicle; and execute a driver monitoring system (DMS) using the encrypted machine learning trained model.

Another example (e.g. example 21) relates to a previously-described example (e.g. example 20), wherein the user data comprises images of a user identified with a driver of the vehicle that utilizes the DMS.

Another example (e.g. example 22) relates to a previously-described example (e.g. one or more of examples 20-21), wherein the processor is configured to execute the computer-readable instructions to decrypt the encrypted machine learning trained model using a decryption key that is stored in the secure location of the memory, and to store the decrypted machine learning trained model in the secure location of the memory.

Another example (e.g. example 23) relates to a previously-described example (e.g. one or more of examples 20-22), wherein the encrypted communication channel is established in response to a handshake request transmitted to the cloud enclave that is initiated by the vehicle.

Another example (e.g. example 24) relates to a previously-described example (e.g. one or more of examples 20-23), wherein the processor is configured to execute the computer-readable instructions to cause the vehicle to store the encrypted machine learning trained model in the memory conditioned upon approval of a consent request transmitted from the cloud enclave to a user equipment (UE).

Another example (e.g. example 25) relates to a previously-described example (e.g. one or more of examples 20-24), further comprising: a sensor configured to acquire further user data, wherein the encrypted machine learning trained model is generated via the computing device using the training data set that includes the user data and the further user data.

An example (e.g. example 26) relates to a computer-readable medium having instructions stored thereon that, when executed by a processor identified with a computing device, cause the computing device to: generate an enclave that is executed in a secure location of memory that is protected by the processor; store user data received via an encrypted communication channel established between the enclave and a user equipment (UE) in the secure location of the memory as part of a training dataset; generate a machine learning trained model using the training dataset; and transmit the machine learning trained model to a vehicle that utilizes the machine learning trained model as part of a driver monitoring system (DMS).

Another example (e.g. example 27) relates to a previously-described example (e.g. example 26), wherein the user data comprises images of a user identified with a driver of the vehicle that utilizes the DMS.

Another example (e.g. example 28) relates to a previously-described example (e.g. one or more of examples 26-27), wherein the instructions, when executed by the processor, cause the computing device to generate the machine learning trained model by re-training a previously-trained machine learning trained model using the training dataset.

Another example (e.g. example 29) relates to a previously-described example (e.g. one or more of examples 26-28), wherein the instructions, when executed by the processor, cause the computing device to encrypt the machine learning trained model with a key that is stored in the secure location of the memory to generate an encrypted machine learning trained model.

Another example (e.g. example 30) relates to a previously-described example (e.g. one or more of examples 26-29), wherein the encrypted machine learning trained model is stored in a portion of the memory other than the secure location of the memory.

Another example (e.g. example 31) relates to a previously-described example (e.g. one or more of examples 26-30), wherein the instructions, when executed by the processor, cause the computing device to establish the encrypted communication channel via an attestation procedure performed with the UE.

Another example (e.g. example 32) relates to a previously-described example (e.g. one or more of examples 26-31), wherein the instructions, when executed by the processor, cause the computing device to establish a further encrypted communication channel between the computing device and the vehicle using an attestation request that is initiated by the computing device, and to transmit the encrypted machine learning trained model to the vehicle via the further encrypted communication channel.

An example (e.g. example 33) relates to a vehicle. The vehicle includes a memory configured to store computer-readable instructions, and a processing means for executing the computer-readable instructions to cause the computing device to: receive settings associated with a user privacy profile, the settings corresponding to a selection of sensors that are authorized to collect sensor data in accordance with an in-vehicle monitoring system during vehicle operation; and execute the in-vehicle monitoring system to collect sensor data using sensors in the vehicle that are based upon an application of the settings associated with the user privacy profile.

Another example (e.g. example 34) relates to a previously-described example (e.g. example 33), wherein the processing means executes the computer-readable instructions to cause the vehicle to transmit data to a user equipment (UE) indicative of sensors in the vehicle that are being used to collect the sensor data while executing the in-vehicle monitoring system.

Another example (e.g. example 35) relates to a previously-described example (e.g. one or more of examples 33-34), wherein the processing means executes the computer-readable instructions to cause the vehicle to execute the in-vehicle monitoring system to collect sensor data using sensors in the vehicle that are mapped to sensors identified by the settings associated with the user privacy profile.

Another example (e.g. example 36) relates to a previously-described example (e.g. one or more of examples 33-35), wherein the processing means executes the computer-readable instructions to cause the vehicle to receive modified settings associated with a modified user privacy profile.

Another example (e.g. example 37) relates to a previously-described example (e.g. one or more of examples 33-36), wherein the vehicle includes additional sensors that cannot be mapped to sensors identified by the settings associated with the user privacy profile, the modified settings correspond to a further selection of the additional sensors in the vehicle that are authorized to collect sensor data in accordance with the in-vehicle monitoring system during vehicle operation, and the processing means executes the computer-readable instructions to cause the vehicle to execute the in-vehicle monitoring system to collect sensor data using sensors in the vehicle that are based upon an application of the modified settings associated with the modified user privacy profile.

Another example (e.g. example 38) relates to a previously-described example (e.g. one or more of examples 33-37), wherein the user privacy profile is from among a plurality of user privacy profiles, each one of the plurality of user profiles being associated with a respective user's settings corresponding to a selection of sensors that are authorized to collect sensor data in accordance with the in-vehicle monitoring system during vehicle operation, and wherein the processing means executes the computer-readable instructions to cause the vehicle to execute the in-vehicle monitoring system to collect sensor data using sensors in the vehicle that are based upon settings from among the plurality of user privacy profiles.

An example (e.g. example 39) relates to a vehicle. The vehicle includes a memory configured to store computer-readable instructions, and a processing means for executing the computer-readable instructions to cause the vehicle to: receive a machine learning trained model that is trained using a training dataset that identifies a driver monitoring system (DMS) function; receive sensor data associated with an occupant of the vehicle; and execute a DMS to perform a DMS-based function using the machine learning trained model based upon the sensor data, wherein the training dataset is based upon a three-dimensional (3D) model that is specific to the occupant of the vehicle.

Another example (e.g. example 40) relates to a previously-described example (e.g. example 39), wherein the 3D model that is specific to the occupant of the vehicle comprises a 3D rendering of a portion of the occupant of the vehicle.

Another example (e.g. example 41) relates to a previously-described example (e.g. one or more of examples 39-40), wherein the 3D model is generated based upon a portion of a 3D mesh of the occupant of the vehicle, which is overlaid onto a reference 3D model that is associated with a DMS-based function for which the machine learning trained model is trained to enable the DMS to perform.

Another example (e.g. example 42) relates to a previously-described example (e.g. one or more of examples 39-41), a sensor configured to generate further sensor data identified with the occupant of the vehicle during execution of the DMS, wherein the 3D model that is specific to the occupant of the vehicle is modified using the further sensor data to generate a modified 3D model.

Another example (e.g. example 43) relates to a previously-described example (e.g. one or more of examples 39-42), wherein the processing means executes the computer-readable instructions to execute the DMS to perform the DMS-based function using the machine learning trained model that has been re-trained using a further training dataset that is based upon the modified 3D model.

Another example (e.g. example 44) relates to a previously-described example (e.g. one or more of examples 39-43), wherein the machine learning trained model is from among a plurality of machine learning trained models, with each one of the plurality of machine learning trained models being trained using a user-specific training dataset that is associated with a respective DMS-based function for which each respective machine learning trained model is trained to enable the DMS to perform.

An example (e.g. example 45) relates to a computing device. The computing device includes a memory configured to store computer-readable instructions, and a processing means for executing the computer-readable instructions to cause the computing device to: generate an enclave that is executed in a secure location of the memory and is protected by the processing means; store user data received via an encrypted communication channel established between the enclave and a user equipment (UE) in the secure location of the memory as part of a training dataset; generate a machine learning trained model using the training dataset; and transmit the machine learning trained model to a vehicle that utilizes the machine learning trained model as part of a driver monitoring system (DMS).

Another example (e.g. example 46) relates to a previously-described example (e.g. example 45), wherein the user data comprises images of a user identified with a driver of the vehicle that utilizes the DMS.

Another example (e.g. example 47) relates to a previously-described example (e.g. one or more of examples 45-46), wherein the processing means executes the computer-readable instructions to generate the machine learning trained model by re-training a previously-trained machine learning trained model using the training dataset.

Another example (e.g. example 48) relates to a previously-described example (e.g. one or more of examples 45-47), wherein the processing means executes the computer-readable instructions to encrypt the machine learning trained model with a key that is stored in the secure location of the memory to generate an encrypted machine learning trained model.

Another example (e.g. example 49) relates to a previously-described example (e.g. one or more of examples 45-48), wherein the encrypted machine learning trained model is stored in a portion of the memory other than the secure location.

Another example (e.g. example 50) relates to a previously-described example (e.g. one or more of examples 45-49), wherein the processing means executes the computer-readable instructions to cause the computing device to establish the encrypted communication channel via an attestation procedure performed with the UE.

Another example (e.g. example 51) relates to a previously-described example (e.g. one or more of examples 45-50), wherein the processing means executes the computer-readable instructions to cause the computing device to establish a further encrypted communication channel between the computing device and the vehicle using an attestation request that is initiated by the computing device, and to transmit the encrypted machine learning trained model to the vehicle via the further encrypted communication channel.

An example (e.g. example 52) relates to a vehicle. The vehicle includes a memory configured to store computer-readable instructions; and a processing means for executing the computer-readable instructions to cause the vehicle to: generate a vehicle enclave that is executed in a secure location of the memory protected by the processing means; establish an encrypted communication channel between the vehicle enclave and a cloud enclave associated with a computing device; store an encrypted machine learning trained model received from the cloud enclave via the encrypted communication channel in the memory, the encrypted machine learning trained model being generated via the computing device using a training data set that includes user data identified with the vehicle; and execute a driver monitoring system (DMS) using the encrypted machine learning trained model.

Another example (e.g. example 53) relates to a previously-described example (e.g. example 52), wherein the user data comprises images of a user identified with a driver of the vehicle that utilizes the DMS.

Another example (e.g. example 54) relates to a previously-described example (e.g. one or more of examples 52-53), wherein the processing means executes the computer-readable instructions to decrypt the encrypted machine learning trained model using a decryption key that is stored in the secure location of the memory, and to store the decrypted machine learning trained model in the secure location of the memory.

Another example (e.g. example 55) relates to a previously-described example (e.g. one or more of examples 52-54), wherein the encrypted communication channel is established in response to a handshake request transmitted to the cloud enclave that is initiated by the vehicle.

Another example (e.g. example 56) relates to a previously-described example (e.g. one or more of examples 52-55), wherein the processing means executes the computer-readable instructions to cause the vehicle to store the encrypted machine learning trained model in the memory conditioned upon approval of a consent request transmitted from the cloud enclave to a user equipment (UE).

Another example (e.g. example 57) relates to a previously-described example (e.g. one or more of examples 52-56), further comprising: a sensor configured to acquire further user data, wherein the encrypted machine learning trained model is generated via the computing device using the training data set that includes the user data and the further user data.

An example (e.g. example 58) relates to a computer-readable medium having instructions stored thereon that, when executed by a processing means identified with a computing device, cause the computing device to: generate an enclave that is executed in a secure location of memory that is protected by the processor; store user data received via an encrypted communication channel established between the enclave and a user equipment (UE) in the secure location of the memory as part of a training dataset; generate a machine learning trained model using the training dataset; and transmit the machine learning trained model to a vehicle that utilizes the machine learning trained model as part of a driver monitoring system (DMS).

Another example (e.g. example 59) relates to a previously-described example (e.g. example 58), wherein the user data comprises images of a user identified with a driver of the vehicle that utilizes the DMS.

Another example (e.g. example 60) relates to a previously-described example (e.g. one or more of examples 58-59), wherein the instructions, when executed by the processing means, cause the computing device to generate the machine learning trained model by re-training a previously-trained machine learning trained model using the training dataset.

Another example (e.g. example 61) relates to a previously-described example (e.g. one or more of examples 58-60), wherein the instructions, when executed by the processing means, cause the computing device to encrypt the machine learning trained model with a key that is stored in the secure location of the memory to generate an encrypted machine learning trained model.

Another example (e.g. example 62) relates to a previously-described example (e.g. one or more of examples 58-61), wherein the encrypted machine learning trained model is stored in a portion of the memory other than the secure location of the memory.

Another example (e.g. example 63) relates to a previously-described example (e.g. one or more of examples 58-62), wherein the instructions, when executed by the processing means, cause the computing device to establish the encrypted communication channel via an attestation procedure performed with the UE.

Another example (e.g. example 64) relates to a previously-described example (e.g. one or more of examples 58-63), wherein the instructions, when executed by the processing means, cause the computing device to establish a further encrypted communication channel between the computing device and the vehicle using an attestation request that is initiated by the computing device, and to transmit the encrypted machine learning trained model to the vehicle via the further encrypted communication channel.

An apparatus as shown and described.

A method as shown and described.

### Conclusion

The aforementioned description will so fully reveal the general nature of the implementation of the disclosure that others can, by applying knowledge within the skill of the art, readily modify and/or adapt for various applications such specific implementations without undue experimentation and without departing from the general concept of the present disclosure. Therefore, such adaptations and modifications are intended to be within the meaning and range of equivalents of the disclosed implementations, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Each implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to affect such feature, structure, or characteristic in connection with other implementations whether or not explicitly described.

The exemplary implementations described herein are provided for illustrative purposes, and are not limiting. Other implementations are possible, and modifications may be made to the exemplary implementations. Therefore, the specification is not meant to limit the disclosure. Rather, the scope of the disclosure is defined only in accordance with the following claims and their equivalents.

The designs of the disclosure may be implemented in hardware (e.g., circuits), firmware, software, or any combination thereof. Designs may also be implemented as instructions stored on a machine-readable medium, which may be read and executed by one or more processors. A machine-readable medium may include any mechanism for storing or transmitting information in a form readable by a machine (e.g., a computing device). A machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general purpose computer.

Throughout the drawings, it should be noted that like reference numbers are used to depict the same or similar elements, features, and structures, unless otherwise noted.

The terms “at least one” and “one or more” may be understood to include a numerical quantity greater than or equal to one (e.g., one, two, three, four, [. . . ], etc.). The term “a plurality” may be understood to include a numerical quantity greater than or equal to two (e.g., two, three, four, five, [. . . ], etc.).

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. The terms “group (of)”, “set (of)”, “collection (of)”, “series (of)”, “sequence (of)”, “grouping (of)”, etc., and the like in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The phrase “at least one of” with regard to a group of elements may be used herein to mean at least one element from the group consisting of the elements. The phrase “at least one of” with regard to a group of elements may be used herein to mean a selection of: one of the listed elements, a plurality of one of the listed elements, a plurality of individual listed elements, or a plurality of a multiple of individual listed elements.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned data types and may take various forms and represent any information as understood in the art.

The terms “processor” or “controller” as used herein may be understood as any kind of technological entity that allows handling of data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

As used herein, “memory” is understood as a computer-readable medium in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, among others, or any combination thereof. Registers, shift registers, processor registers, data buffers, among others, are also embraced herein by the term memory. The term “software” refers to any type of executable instruction, including firmware.

In one or more of the implementations described herein, processing circuitry can include memory that stores data and/or instructions. The memory can be any well-known volatile and/or non-volatile memory, including read-only memory (ROM), random access memory (RAM), flash memory, a magnetic storage media, an optical disc, erasable programmable read only memory (EPROM), and programmable read only memory (PROM). The memory can be non-removable, removable, or a combination of both.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). A processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both ‘direct’ calculations via a mathematical expression/formula/relationship and ‘indirect’ calculations via lookup or hash tables and other array indexing or searching operations.

A “vehicle” may be understood to include any type of driven object. A vehicle may be a driven object with a combustion engine, a reaction engine, an electrically driven object, a hybrid driven object, or a combination thereof. A vehicle may be or may include an automobile, a bus, a mini bus, a van, a truck, a mobile home, a vehicle trailer, a motorcycle, a bicycle, a tricycle, a train locomotive, a train wagon, a moving robot, a personal transporter, a boat, a ship, a submersible, a submarine, a drone, an aircraft, a rocket, and the like.

The term “autonomous vehicle” may describe a vehicle that implements all or substantially all navigational changes, at least during some (significant) part (spatial or temporal, e.g., in certain areas, or when ambient conditions are fair, or on highways, or above or below a certain speed) of some drives. Sometimes an “autonomous vehicle” is distinguished from a “partially autonomous vehicle” or a “semi-autonomous vehicle” to indicate that the vehicle is capable of implementing some (but not all) navigational changes, possibly at certain times, under certain conditions, or in certain areas. A navigational change may describe or include a change in one or more of steering, braking, or acceleration/deceleration of the vehicle. A vehicle may be described as autonomous even in case the vehicle is not fully automatic (fully operational with driver or without driver input). Autonomous vehicles may include those vehicles that can operate under driver control during certain time periods and without driver control during other time periods. Autonomous vehicles may also include vehicles that control only some implementations of vehicle navigation, such as steering (e.g., to maintain a vehicle course between vehicle lane constraints) or some steering operations under certain circumstances (but not under all circumstances), but may leave other implementations of vehicle navigation to the driver (e.g., braking or braking under certain circumstances). Autonomous vehicles may also include vehicles that share the control of one or more implementations of vehicle navigation under certain circumstances (e.g., hands-on, such as responsive to a driver input) and vehicles that control one or more implementations of vehicle navigation under certain circumstances (e.g., hands-off, such as independent of driver input). Autonomous vehicles may also include vehicles that control one or more implementations of vehicle navigation under certain circumstances, such as under certain environmental conditions (e.g., spatial areas, roadway conditions). In some implementations, autonomous vehicles may handle some or all implementations of braking, speed control, velocity control, and/or steering of the vehicle. An autonomous vehicle may include those vehicles that can operate without a driver. The level of autonomy of a vehicle may be described or determined by the Society of Automotive Engineers (SAE) level of the vehicle (as defined by the SAE in SAE J3016 2018: Taxonomy and definitions for terms related to driving automation systems for on road motor vehicles) or by other relevant professional organizations. The SAE level may have a value ranging from a minimum level, e.g. level 0 (illustratively, substantially no driving automation), to a maximum level, e.g. level 5 (illustratively, full driving automation).

What is claimed is:

1. A computing device, comprising:
a memory configured to store computer-readable instructions; and
a processor configured to execute the computer-readable instructions to cause the computing device to:
generate an enclave that is executed in a secure location of the memory and is protected by the processor;
store user data received via an encrypted communication channel established between the enclave and a user equipment (UE) in the secure location of the memory as part of a training dataset;
generate a machine learning trained model using the training dataset; and
transmit the machine learning trained model to a vehicle that utilizes the machine learning trained model as part of a driver monitoring system (DMS).

2. The computing device of claim 1, wherein the user data comprises images of a user identified with a driver of the vehicle that utilizes the DMS.

3. The computing device of claim 1, wherein the processor is configured to execute the computer-readable instructions to generate the machine learning trained model by re-training a previously-trained machine learning trained model using the training dataset.

4. The computing device of claim 1, wherein the processor is configured to execute the computer-readable instructions to encrypt the machine learning trained model with a key that is stored in the secure location of the memory to generate an encrypted machine learning trained model.

5. The computing device of claim 4, wherein the encrypted machine learning trained model is stored in a portion of the memory other than the secure location.

6. The computing device of claim 1, wherein the processor is configured to execute the computer-readable instructions to cause the computing device to establish the encrypted communication channel via an attestation procedure performed with the UE.

7. The computing device of claim 4, wherein the processor is configured to execute the computer-readable instructions to cause the computing device to establish a further encrypted communication channel between the computing device and the vehicle using an attestation request that is initiated by the computing device, and to transmit the encrypted machine learning trained model to the vehicle via the further encrypted communication channel.

8. A vehicle comprising:
a memory configured to store computer-readable instructions; and
a processor configured to execute the computer-readable instructions to cause the vehicle to:
generate a vehicle enclave that is executed in a secure location of the memory protected by the processor;
establish an encrypted communication channel between the vehicle enclave and a cloud enclave associated with a computing device;
store an encrypted machine learning trained model received from the cloud enclave via the encrypted communication channel in the memory, the encrypted machine learning trained model being generated via the computing device using a training data set that includes user data identified with the vehicle; and
execute a driver monitoring system (DMS) using the encrypted machine learning trained model.

9. The vehicle of claim 8, wherein the user data comprises images of a user identified with a driver of the vehicle that utilizes the DMS.

10. The vehicle of claim 8, wherein the processor is configured to execute the computer-readable instructions to decrypt the encrypted machine learning trained model using a decryption key that is stored in the secure location of the memory, and to store the decrypted machine learning trained model in the secure location of the memory.

11. The vehicle of claim 8, wherein the encrypted communication channel is established in response to a handshake request transmitted to the cloud enclave that is initiated by the vehicle.

12. The vehicle of claim 9, wherein the processor is configured to execute the computer-readable instructions to cause the vehicle to store the encrypted machine learning trained model in the memory conditioned upon approval of a consent request transmitted from the cloud enclave to a user equipment (UE).

13. The vehicle of claim 8, further comprising:
a sensor configured to acquire further user data,
wherein the encrypted machine learning trained model is generated via the computing device using the training data set that includes the user data and the further user data.

14. A computer-readable medium having instructions stored thereon that, when executed by a processor identified with a computing device, cause the computing device to:
generate an enclave that is executed in a secure location of memory that is protected by the processor;
store user data received via an encrypted communication channel established between the enclave and a user equipment (UE) in the secure location of the memory as part of a training dataset;
generate a machine learning trained model using the training dataset; and
transmit the machine learning trained model to a vehicle that utilizes the machine learning trained model as part of a driver monitoring system (DMS).

15. The computer-readable medium of claim 14, wherein the user data comprises images of a user identified with a driver of the vehicle that utilizes the DMS.

16. The computer-readable medium of claim 14, wherein the instructions, when executed by the processor, cause the computing device to generate the machine learning trained model by re-training a previously-trained machine learning trained model using the training dataset.

17. The computer-readable medium of claim 14, wherein the instructions, when executed by the processor, cause the computing device to encrypt the machine learning trained model with a key that is stored in the secure location of the memory to generate an encrypted machine learning trained model.

18. The computer-readable medium of claim 17, wherein the encrypted machine learning trained model is stored in a portion of the memory other than the secure location of the memory.

19. The computer-readable medium of claim 14, wherein the instructions, when executed by the processor, cause the computing device to establish the encrypted communication channel via an attestation procedure performed with the UE.

20. The computer-readable medium of claim 17, wherein the instructions, when executed by the processor, cause the computing device to establish a further encrypted communication channel between the computing device and the vehicle using an attestation request that is initiated by the computing device, and to transmit the encrypted machine learning trained model to the vehicle via the further encrypted communication channel.
